SEQUENCE LISTING (120 sequences)

SEQ ID NO: 1 - DNA, 182 bp, Escherichia coli K-12 MG1655 complete genome
  (4505026)...(4505207): Chromosome =   1  Contig =  1  Strand = pos CtronObjNum =    7435
ctgtagattcaatctgtcaatgcaacacccctttcaattatctctttcggtgttttgaacttcagtgtctttctcggtctgttgtttagctgagcagcaaccagatctagttcatgttgagtatattgggcaagacatgtctttttaggaaagtactgccgaattagcccatttgtgttctc

SEQ ID NO: 2 - DNA, 182 bp, Escherichia coli K-12 MG1655 complete genome; identical to SEQ ID NO: 1
  (279155)...(279336): Chromosome =   1  Contig =  1  Strand = neg CtronObjNum =     508

SEQ ID NO: 3 - DNA, 171 bp, Escherichia coli K-12 MG1655 complete genome
  (4505031)...(4505201): Chromosome =   1  Contig =  1  Strand = pos CtronObjNum =    7435
gattcaatctgtcaatgcaacacccctttcaattatctctttcggtgttttgaacttcagtgtctttctcggtctgttgtttagctgagcagcaaccagatctagttcatgttgagtatattgggcaagacatgtctttttaggaaagtactgccgaattagcccatttgt

SEQ ID NO: 4 - DNA, 171 bp, Escherichia coli K-12 MG1655 complete genome; identical to SEQ ID NO: 3
  (270811)...(270981): Chromosome =   1  Contig =  1  Strand = neg CtronObjNum =     472

SEQ ID NO: 5 - DNA, 67 bp, Sulfolobus tokodaii complete genome
  (1178996)...(1179062): Chromosome =   1  Contig =  1  Strand = neg CtronObjNum =    3986
tgtacccccttcaagtaagcctcatttaagggagttttctcccttgaataaactaccgggtacatga

SEQ ID NO: 6 - DNA, 67 bp, Sulfolobus tokodaii complete genome; identical to SEQ ID NO: 5
  (61903)...(61969): Chromosome =   1  Contig =  1  Strand = pos CtronObjNum =     447

SEQ ID NO: 7 - DNA, 85 bp, Sulfolobus tokodaii complete genome
  (1178963)...(1179047): Chromosome =   1  Contig =  1  Strand = neg CtronObjNum =    3986
ttgtaatattatatcagtttacttctaatatactgtacccccttcaagtaagcctcatttaagggagttttctcccttgaataaa

SEQ ID NO: 8 - DNA, 85 bp, Sulfolobus tokodaii complete genome; identical to SEQ ID NO: 7
  (123599)...(123683): Chromosome =   1  Contig =  1  Strand = pos CtronObjNum =     646

SEQ ID NO: 9 - DNA, 117 bp, Saccharomyces cerevisiae complete genome
  (975950)...(976066): Chromosome =  15  Contig = 15  Strand = pos CtronObjNum =   28455
ttactagtatattatcatatacggtgttagaagatgacgcaaatgatgagaaatagtcatctaaattagtggaagctgaaacgcaaggattgataatgtaataggatcaatgaatat

SEQ ID NO: 10 - DNA, 117 bp, Saccharomyces cerevisiae complete genome; identical to SEQ ID NO: 9
  (165888)...(166004): Chromosome =   1  Contig =  1  Strand = neg CtronObjNum =     419

SEQ ID NO: 11 - DNA, 117 bp, Saccharomyces cerevisiae complete genome; identical to SEQ ID NO: 9
  (975950)...(976066): Chromosome =  15  Contig = 15  Strand = pos CtronObjNum =   28455

SEQ ID NO: 12 - DNA, 117 bp, Saccharomyces cerevisiae complete genome; identical to SEQ ID NO: 9
  (160257)...(160373): Chromosome =   1  Contig =  1  Strand = neg CtronObjNum =     355

SEQ ID NO: 13 - DNA, 68 bp, Caenorhabditis elegans complete genome
  (221205)...(221272): Chromosome =   1  Contig =  1  Strand = neg CtronObjNum =     380
gggaattgcttcgtcaaatgatcgacggagggcttttggccatctgcaaggataaactcgcatgtcga

SEQ ID NO: 14 - DNA, 68 bp, Caenorhabditis elegans complete genome; identical to SEQ ID NO: 13
  (250979)...(251046): Chromosome =   1  Contig =  1  Strand = neg CtronObjNum =     433

SEQ ID NO: 15 - DNA, 68 bp, Caenorhabditis elegans complete genome
  (221180)...(221247): Chromosome =   1  Contig =  1  Strand = neg CtronObjNum =     380
gagctcgcaacaccggccgagcagcgggaattgcttcgtcaaatgatcgacggagggcttttggccat

SEQ ID NO: 16 - DNA, 68 bp, Caenorhabditis elegans complete genome; identical to SEQ ID NO: 15
  (214904)...(214971): Chromosome =   1  Contig =  1  Strand = neg CtronObjNum =     354

SEQ ID NO: 17 - DNA, 58 bp, Homo sapiens complete genome
  (16381)...(16438): Chromosome =   4  Contig =  1  Strand = pos CtronObjNum =    1331
ggtgagtacctttctatgaaggtgataaggatccactgagtcttccatataaagatca

SEQ ID NO: 18 - DNA, 58 bp, Homo sapiens complete genome; identical to SEQ ID NO: 17
  (500217)...(500274): Chromosome =   4  Contig =  1  Strand = pos CtronObjNum =    1542

SEQ ID NO: 19 - DNA, 58 bp, Homo sapiens complete genome; identical to SEQ ID NO: 17
  (16381)...(16438): Chromosome =   4  Contig =  1  Strand = pos CtronObjNum =    1331

SEQ ID NO: 20 - DNA, 58 bp, Homo sapiens complete genome; identical to SEQ ID NO: 17
  (504937)...(504994): Chromosome =   4  Contig =  1  Strand = pos CtronObjNum =    1559

SEQ ID NO: 21 - DNA, 94 bp, Arabidopsis thaliana complete genome
  (21590870)...(21590960): Chromosome =   5  Contig =  1  Strand = neg CtronObjNum =   29822
tgttgaaagttaaacttgattttgaatcaagtttaattattggatcaattatccaataattaattatggccaaatccaagttctagagttttct

SEQ ID NO: 22 - DNA, 94 bp, Arabidopsis thaliana complete genome; identical to SEQ ID NO: 21
  (3780765)...(3780858): Chromosome =   1  Contig =  1  Strand = pos CtronObjNum =    7951

SEQ ID NO: 23 - DNA, 79 bp, Arabidopsis thaliana complete genome
  (21590870)...(21590950): Chromosome =   5  Contig =  1  Strand = neg CtronObjNum =   29822
tgttgaaagttaaacttgattttgaatcaagtttaattattggatcaattatccaataattaattatggccaaatccaa

SEQ ID NO: 24 - DNA, 79 bp, Arabidopsis thaliana complete genome; identical to SEQ ID NO: 23
  (3785281)...(3785359): Chromosome =   1  Contig =  1  Strand = pos CtronObjNum =    7985

SEQ ID NO: 25 - DNA, 27 bp, Escherichia coli K-12 MG1655 complete genome
  (4454807)...(4454833): Chromosome =   1  Contig =  1  Strand = neg CtronObjNum =    7316
aaatgccggatgcggcgtgaacgcctt

SEQ ID NO: 26 - DNA, 27 bp, Escherichia coli K-12 MG1655 complete genome
  (4242757)...(4242783): Chromosome =   1  Contig =  1  Strand = neg CtronObjNum =    6955
aaatgccggatgcggcgtgaacgcctt

SEQ ID NO: 27 - DNA, 35 bp, Escherichia coli K-12 MG1655 complete genome
  (4454810)...(4454844): Chromosome =   1  Contig =  1  Strand = neg CtronObjNum =    7316
tgccggatgcggcgtgaacgccttatccggcctac

SEQ ID NO: 28 - DNA, 35 bp, Escherichia coli K-12 MG1655 complete genome; identical to SEQ ID NO: 27
  (4233017)...(4233051): Chromosome =   1  Contig =  1  Strand = neg CtronObjNum =    6937

SEQ ID NO: 29 - DNA, 20 bp, Escherichia coli K-12 MG1655 complete genome
  (831575)...(831594): Chromosome =   1  Contig =  1  Strand = pos CtronObjNum =    1544
tgtaggccggataaggcgtt

SEQ ID NO: 30 - DNA, 20 bp, Escherichia coli K-12 MG1655 complete genome
  (4232999)...(4233018): Chromosome =   1  Contig =  1  Strand = pos CtronObjNum =    6939
tgtaggccggataaggcgtt

SEQ ID NO: 31 - DNA, 22 bp, Escherichia coli K-12 MG1655 complete genome
  (831596)...(831617): Chromosome =   1  Contig =  1  Strand = pos CtronObjNum =    1544
acgccgcatccggcatttcaca

SEQ ID NO: 32 - DNA, 22 bp, Escherichia coli K-12 MG1655 complete genome
  (4242783)...(4242804): Chromosome =   1  Contig =  1  Strand = pos CtronObjNum =    6957
acgccgcatccggcatttcaca

SEQ ID NO: 33 - DNA, 59 bp, Sulfolobus tokodaii complete genome
  (1036523)...(1036581): Chromosome =   1  Contig =  1  Strand = pos CtronObjNum =    3245
actcccagtgagggataggggtaacggactgaagacccagcccgtggtctaccgctgga

SEQ ID NO: 34 - DNA, 59 bp, Sulfolobus tokodaii complete genome; identical to SEQ ID NO: 33
  (1079594)...(1079652): Chromosome =   1  Contig =  1  Strand = pos CtronObjNum =    3439

SEQ ID NO: 35 - DNA, 60 bp, Sulfolobus tokodaii complete genome
  (1036635)...(1036694): Chromosome =   1  Contig =  1  Strand = pos CtronObjNum =    3250
atgaaggtggtaaaccacaaacctatgaaccgccctaagggaaccctcgccctttagggc

SEQ ID NO: 36 - DNA, 60 bp, Sulfolobus tokodaii complete genome; identical to SEQ ID NO: 35
  (1146360)...(1146419): Chromosome =   1  Contig =  1  Strand = pos CtronObjNum =    3714

SEQ ID NO: 37 - DNA, 189 bp, Sulfolobus tokodaii complete genome
  (120361)...(120549): Chromosome =   1  Contig =  1  Strand = neg CtronObjNum =     618
ctatccctcaccaagagttgccctctgctcttggctcttggggactcggggatatgtagttctgtgcggggacacatatcttcagtatgcccacctttgtgggcttccccgcactttattaatagttttaagctaagattaaaaactttaccccgccttaaaaggcgaggcttgccccgcgttttgtca

SEQ ID NO: 38 - DNA, 189 bp, Sulfolobus tokodaii complete genome; identical to SEQ ID NO: 37
  (1146169)...(1146357): Chromosome =   1  Contig =  1  Strand = neg CtronObjNum =    3709

SEQ ID NO: 39 - DNA, 36 bp, Sulfolobus tokodaii complete genome
  (120590)...(120625): Chromosome =   1  Contig =  1  Strand = neg CtronObjNum =     622
cacccaccccgctccgttcgtccagcggtagaccac

SEQ ID NO: 40 - DNA, 36 bp, Sulfolobus tokodaii complete genome; identical to SEQ ID NO: 39
  (1079651)...(1079686): Chromosome =   1  Contig =  1  Strand = neg CtronObjNum =    3446

SEQ ID NO: 41 - DNA, 72 bp, Saccharomyces cerevisiae complete genome
  (362701)...(362772): Chromosome =  13  Contig = 13  Strand = pos CtronObjNum =   23498
atggaatctatatttctacatactaatattacgattattcctcattccgttttatatgtttcattatcctat

SEQ ID NO: 42 - DNA, 72 bp, Saccharomyces cerevisiae complete genome; identical to SEQ ID NO: 41
  (265267)...(265338): Chromosome =   2  Contig =  2  Strand = neg CtronObjNum =    1896

SEQ ID NO: 43 - DNA, 72 bp, Saccharomyces cerevisiae complete genome; identical to SEQ ID NO: 41
  (362701)...(362772): Chromosome =  13  Contig = 13  Strand = pos CtronObjNum =   23498

SEQ ID NO: 44 - DNA, 72 bp, Saccharomyces cerevisiae complete genome; identical to SEQ ID NO: 41
  (226820)...(226891): Chromosome =   2  Contig =  2  Strand = neg CtronObjNum =    1495

SEQ ID NO: 45 - DNA, 81 bp, Saccharomyces cerevisiae complete genome
  (372772)...(372852): Chromosome =  13  Contig = 13  Strand = neg CtronObjNum =   23551
aaacatataaaacggaatgaggaataatcgtaatattagtatgtagaaatatagattccattttgaggattcctatatcct

SEQ ID NO: 46 - DNA, 81 bp, Saccharomyces cerevisiae complete genome; identical to SEQ ID NO: 45
  (226739)...(226819): Chromosome =   2  Contig =  2  Strand = pos CtronObjNum =    1496

SEQ ID NO: 47 - DNA, 89 bp, Saccharomyces cerevisiae complete genome
  (372836)...(372924): Chromosome =  13  Contig = 13  Strand = neg CtronObjNum =   23551
gaggattcctatatcctcgaggagaacttctagtatattctgtatacctaatattatagcctttatcaacaatggaatcccaacaatta

SEQ ID NO: 48 - DNA, 89 bp, Saccharomyces cerevisiae complete genome; identical to SEQ ID NO: 47
  (265340)...(265428): Chromosome =   2  Contig =  2  Strand = pos CtronObjNum =    1923

SEQ ID NO: 49 - DNA, 15 bp, Caenorhabditis elegans complete genome
  (708778)...(708792): Chromosome =   4  Contig =  2  Strand = pos CtronObjNum =   22854
tggtctgctaaatcg

SEQ ID NO: 50 - DNA, 15 bp, Caenorhabditis elegans complete genome
  (415203)...(415217): Chromosome =   4  Contig =  2  Strand = pos CtronObjNum =   21925
tggtctgctaaatcg

SEQ ID NO: 51 - DNA, 18 bp, Caenorhabditis elegans complete genome
  (708793)...(708810): Chromosome =   4  Contig =  2  Strand = pos CtronObjNum =   22854
aaacttgtagtttgtagt

SEQ ID NO: 52 - DNA, 18 bp, Caenorhabditis elegans complete genome
  (486479)...(486496): Chromosome =   4  Contig =  2  Strand = pos CtronObjNum =   22166
aaacttgtagtttgtagt

SEQ ID NO: 53 - DNA, 16 bp, Caenorhabditis elegans complete genome
  (1373569)...(1373584): Chromosome =   4  Contig =  2  Strand = neg CtronObjNum =   24763
atttagcagacccaaa

SEQ ID NO: 54 - DNA, 16 bp, Caenorhabditis elegans complete genome
  (486461)...(486476): Chromosome =   4  Contig =  2  Strand = neg CtronObjNum =   22165
atttagcagacccaaa

SEQ ID NO: 55 - DNA, 19 bp, Caenorhabditis elegans complete genome
  (1373554)...(1373572): Chromosome =   4  Contig =  2  Strand = neg CtronObjNum =   24763
aaactacaaatttcgattt

SEQ ID NO: 56 - DNA, 19 bp, Caenorhabditis elegans complete genome
  (415212)...(415230): Chromosome =   4  Contig =  2  Strand = neg CtronObjNum =   21926
aaactacaaatttcgattt

SEQ ID NO: 57 - DNA, 39 bp, Homo sapiens complete genome
  (21789055)...(21789092): Chromosome = 920  Contig = 19  Strand = pos CtronObjNum =  756303
agcccgagccccacctctcccttagggacctccgcccac

SEQ ID NO: 58 - DNA, 39 bp, Homo sapiens complete genome; identical to SEQ ID NO: 57
  (21820715)...(21820754): Chromosome = 920  Contig = 19  Strand = pos CtronObjNum =  756563

SEQ ID NO: 59 - DNA, 41 bp, Homo sapiens complete genome
  (21789080)...(21789121): Chromosome = 920  Contig = 19  Strand = pos CtronObjNum =  756303
acctccgcccaccctaccctcaagccaggatgcccggagcg

SEQ ID NO: 60 - DNA, 41 bp, Homo sapiens complete genome; identical to SEQ ID NO: 59
  (21827379)...(21827420): Chromosome = 920  Contig = 19  Strand = pos CtronObjNum =  756615

SEQ ID NO: 61 - DNA, 40 bp, Homo sapiens complete genome
  (21808781)...(21808820): Chromosome = 920  Contig = 19  Strand = neg CtronObjNum =  756433
cctaagggagaggtggggctcgggctgaatccctcgttgg

SEQ ID NO: 62 - DNA, 40 bp, Homo sapiens complete genome; identical to SEQ ID NO: 61
  (21827338)...(21827377): Chromosome = 920  Contig = 19  Strand = neg CtronObjNum =  756614

SEQ ID NO: 63 - DNA, 34 bp, Homo sapiens complete genome
  (21808740)...(21808773): Chromosome = 920  Contig = 19  Strand = neg CtronObjNum =  756433
gctccgggcatcctggcttgagggtagagtgggc

SEQ ID NO: 64 - DNA, 34 bp, Homo sapiens complete genome; identical to SEQ ID NO: 63
  (21820748)...(21820781): Chromosome = 920  Contig = 19  Strand = neg CtronObjNum =  756564

SEQ ID NO: 65 - DNA, 20 bp, Arabidopsis thaliana complete genome
  (5320517)...(5320536): Chromosome =  18  Contig =  4  Strand = pos CtronObjNum =  269631
ttgtagacgtatggtggtgg

SEQ ID NO: 66 - DNA, 20 bp, Arabidopsis thaliana complete genome
  (5311160)...(5311179): Chromosome =  18  Contig =  4  Strand = pos CtronObjNum =  269507
ttgtagacgtatggtggtgg

SEQ ID NO: 67 - DNA, 30 bp, Arabidopsis thaliana complete genome
  (5320519)...(5320548): Chromosome =  18  Contig =  4  Strand = pos CtronObjNum =  269631
gtagacgtatggtggtggtggagacttgta

SEQ ID NO: 68 - DNA, 30 bp, Arabidopsis thaliana complete genome; identical to SEQ ID NO: 67
  (5340361)...(5340390): Chromosome =  18  Contig =  4  Strand = pos CtronObjNum =  269890

SEQ ID NO: 69 - DNA, 39 bp, Arabidopsis thaliana complete genome
  (5324883)...(5324921): Chromosome =  18  Contig =  4  Strand = neg CtronObjNum =  269741
gctctccaccaccaccatactacagtccatctccaaagg

SEQ ID NO: 70 - DNA, 39 bp, Arabidopsis thaliana complete genome; identical to SEQ ID NO: 69
  (5340322)...(5340360): Chromosome =  18  Contig =  4  Strand = neg CtronObjNum =  269881

SEQ ID NO: 71 - DNA, 16 bp, Arabidopsis thaliana complete genome
  (5324867)...(5324882): Chromosome =  18  Contig =  4  Strand = neg CtronObjNum =  269741
ccaccatacgtctaca

SEQ ID NO: 72 - DNA, 16 bp, Arabidopsis thaliana complete genome
  (5311176)...(5311191): Chromosome =  18  Contig =  4  Strand = neg CtronObjNum =  269509
ccaccatacgtctaca

SEQ ID NO: 73 - DNA, 21 bp, Escherichia coli K-12 MG1655 complete genome
  (2338350)...(2338370): Chromosome =   1  Contig =  1  Strand = neg CtronObjNum =    3906
aacgccttatccggcctacgg

SEQ ID NO: 74 - DNA, 21 bp, Escherichia coli K-12 MG1655 complete genome
  (374169)...(374189): Chromosome =   1  Contig =  1  Strand = pos CtronObjNum =     689
aacgccttatccggcctacgg

SEQ ID NO: 75 - DNA, 19 bp, Escherichia coli K-12 MG1655 complete genome
  (2338380)...(2338398): Chromosome =   1  Contig =  1  Strand = neg CtronObjNum =    3906
gtaggcctgataagacgcg

SEQ ID NO: 76 - DNA, 19 bp, Escherichia coli K-12 MG1655 complete genome
  (376619)...(376637): Chromosome =   1  Contig =  1  Strand = neg CtronObjNum =     707
gtaggcctgataagacgcg

SEQ ID NO: 77 - DNA, 42 bp, Escherichia coli K-12 MG1655 complete genome
  (376712)...(376753): Chromosome =   1  Contig =  1  Strand = pos CtronObjNum =     709
gtaggccggataaggcgttcacgccgcatccggcagtcgtgc

SEQ ID NO: 78 - DNA, 42 bp, Escherichia coli K-12 MG1655 complete genome; identical to SEQ ID NO: 77
  (374152)...(374193): Chromosome =   1  Contig =  1  Strand = neg CtronObjNum =     690

SEQ ID NO: 79 - DNA, 37 bp, Escherichia coli K-12 MG1655 complete genome
  (376717)...(376753): Chromosome =   1  Contig =  1  Strand = pos CtronObjNum =     709
ccggataaggcgttcacgccgcatccggcagtcgtgc

SEQ ID NO: 80 - DNA, 37 bp, Escherichia coli K-12 MG1655 complete genome; identical to SEQ ID NO: 79
  (376617)...(376653): Chromosome =   1  Contig =  1  Strand = pos CtronObjNum =     706

SEQ ID NO: 81 - DNA, 105 bp, Saccharomyces cerevisiae complete genome
  (111321)...(111425): Chromosome =   7  Contig =  7  Strand = neg CtronObjNum =   10928
cggtgttagaagatgacgcaaatgatgagaaatagtcatctaaattagtggaagctgaaacgcaaggattgataatgtaataggatcaatgaatattaacatata

SEQ ID NO: 82 - DNA, 105 bp, Saccharomyces cerevisiae complete genome; identical to SEQ ID NO: 81
  (84359)...(84463): Chromosome =   3  Contig =  3  Strand = pos CtronObjNum =    2988

SEQ ID NO: 83 - DNA, 38 bp, Saccharomyces cerevisiae complete genome
  (111449)...(111486): Chromosome =   7  Contig =  7  Strand = neg CtronObjNum =   10945
tcatctactaactagtatttacgttactagtatattat

SEQ ID NO: 84 - DNA, 38 bp, Saccharomyces cerevisiae complete genome; identical to SEQ ID NO: 83
  (168765)...(168802): Chromosome =   3  Contig =  3  Strand = neg CtronObjNum =    3500

SEQ ID NO: 85 - DNA, 152 bp, Saccharomyces cerevisiae complete genome
  (645641)...(645792): Chromosome =   4  Contig =  4  Strand = neg CtronObjNum =    5116
tcatctactaactagtatttacgttactagtatattatcatatacggtgttagaagatgacgcaaatgatgagaaatagtcatctaaattagtggaagctgaaacgcaaggattgataatgtaataggatcaatgaatattaacatataaaa

SEQ ID NO: 86 - DNA, 152 bp, Saccharomyces cerevisiae complete genome; identical to SEQ ID NO: 85
  (84315)...(84466): Chromosome =   3  Contig =  3  Strand = pos CtronObjNum =    2991

SEQ ID NO: 87 - DNA, 143 bp, Saccharomyces cerevisiae complete genome
  (645641)...(645783): Chromosome =   4  Contig =  4  Strand = neg CtronObjNum =    5116
tcatctactaactagtatttacgttactagtatattatcatatacggtgttagaagatgacgcaaatgatgagaaatagtcatctaaattagtggaagctgaaacgcaaggattgataatgtaataggatcaatgaatattaa

SEQ ID NO: 88 - DNA, 143 bp, Saccharomyces cerevisiae complete genome; identical to SEQ ID NO: 87
  (168762)...(168904): Chromosome =   3  Contig =  3  Strand = neg CtronObjNum =    3496

SEQ ID NO: 89 - DNA, 34 bp, Caenorhabditis elegans complete genome
  (13819470)...(13819500): Chromosome =   6  Contig =  2  Strand = neg CtronObjNum =   51392
accgaacccaacggccctctttagggccacaaat

SEQ ID NO: 90 - DNA, 34 bp, Caenorhabditis elegans complete genome; identical to SEQ ID NO: 89
  (13817594)...(13817630): Chromosome =   6  Contig =  2  Strand = neg CtronObjNum =   51379

SEQ ID NO: 91 - DNA, 34 bp, Caenorhabditis elegans complete genome; identical to SEQ ID NO: 89
  (13819470)...(13819500): Chromosome =   6  Contig =  2  Strand = neg CtronObjNum =   51392

SEQ ID NO: 92 - DNA, 34 bp, Caenorhabditis elegans complete genome; identical to SEQ ID NO: 89
  (13820550)...(13820583): Chromosome =   6  Contig =  2  Strand = pos CtronObjNum =   51400

SEQ ID NO: 93 - DNA, 48 bp, Caenorhabditis elegans complete genome
  (13820791)...(13820840): Chromosome =   6  Contig =  2  Strand = neg CtronObjNum =   51410
caacacacctaaccgaacccaacggccctctttagggccacaaatgtt

SEQ ID NO: 94 - DNA, 48 bp, Caenorhabditis elegans complete genome; identical to SEQ ID NO: 93
  (13817583)...(13817630): Chromosome =   6  Contig =  2  Strand = neg CtronObjNum =   51379

SEQ ID NO: 95 - DNA, 39 bp, Caenorhabditis elegans complete genome
  (13820800)...(13820840): Chromosome =   6  Contig =  2  Strand = neg CtronObjNum =   51410
ctaaccgaacccaacggccctctttagggccacaaatgt

SEQ ID NO: 96 - DNA, 39 bp, Caenorhabditis elegans complete genome; identical to SEQ ID NO: 95
  (13820550)...(13820584): Chromosome =   6  Contig =  2  Strand = pos CtronObjNum =   51400

SEQ ID NO: 97 - DNA, 28 bp, Arabidopsis thaliana complete genome
  (12540150)...(12540174): Chromosome =  15  Contig =  3  Strand = neg CtronObjNum =  102175
atcatcaatgaactcatttggctaaggt

SEQ ID NO: 98 - DNA, 28 bp, Arabidopsis thaliana complete genome
  (13558720)...(13558750): Chromosome =  15  Contig =  3  Strand = neg CtronObjNum =  102902
atcatcaatgaactcatttggctaaggt

SEQ ID NO: 99 - DNA, 35 bp, Arabidopsis thaliana complete genome
  (12540184)...(12540220): Chromosome =  15  Contig =  3  Strand = neg CtronObjNum =  102176
acattcattagttctggaacgtgaatcaagcaatg

SEQ ID NO: 100 - DNA, 35 bp, Arabidopsis thaliana complete genome; identical to SEQ ID NO: 99
  (13634210)...(13634240): Chromosome =  15  Contig =  3  Strand = pos CtronObjNum =  103090

SEQ ID NO: 101 - DNA, 37 bp, Arabidopsis thaliana complete genome
  (13626660)...(13626700): Chromosome =  15  Contig =  3  Strand = pos CtronObjNum =  103067
atgcatcatcaatgaactcatttggctaaggtgaagg

SEQ ID NO: 102 - DNA, 37 bp, Arabidopsis thaliana complete genome; identical to SEQ ID NO: 101
  (13558713)...(13558750): Chromosome =  15  Contig =  3  Strand = neg CtronObjNum =  102902

SEQ ID NO: 103 - DNA, 68 bp, Arabidopsis thaliana complete genome
  (13626624)...(13626691): Chromosome =  15  Contig =  3  Strand = pos CtronObjNum =  103067
tttaacattcattagttctggaacgtgaatcaagcaatgcatcatcaatgaactcatttggctaaggt

SEQ ID NO: 104 - DNA, 68 bp, Arabidopsis thaliana complete genome; identical to SEQ ID NO: 103
  (13634202)...(13634270): Chromosome =  15  Contig =  3  Strand = pos CtronObjNum =  103090

SEQ ID NO: 105 - DNA, 82 bp, Saccharomyces cerevisiae complete genome
  (84112)...(84193): Chromosome =   3  Contig =  3  Strand = pos CtronObjNum =    2944
atacgtttgaagaaatcactttatggattgaaacaaagtggagcgaactggtacgaaactatcaaatcatacctgataaaac

SEQ ID NO: 106 - DNA, 82 bp, Saccharomyces cerevisiae complete genome; identical to SEQ ID NO: 105
  (82743)...(82824): Chromosome =   3  Contig =  3  Strand = pos CtronObjNum =    2901

SEQ ID NO: 107 - DNA, 34 bp, Saccharomyces cerevisiae complete genome
  (84195)...(84228): Chromosome =   3  Contig =  3  Strand = pos CtronObjNum =    2965
gaaacgtgacggtactcataaagctagatttgtt

SEQ ID NO: 108 - DNA, 34 bp, Saccharomyces cerevisiae complete genome; identical to SEQ ID NO: 107
  (169327)...(169360): Chromosome =   3  Contig =  3  Strand = pos CtronObjNum =    3529

SEQ ID NO: 109 - DNA, 16 bp, Saccharomyces cerevisiae complete genome
  (151534)...(151549): Chromosome =   3  Contig =  3  Strand = neg CtronObjNum =    3387
taattgttgggattcc

SEQ ID NO: 110 - DNA, 16 bp, Saccharomyces cerevisiae complete genome
  (169308)...(169323): Chromosome =   3  Contig =  3  Strand = neg CtronObjNum =    3526
taattgttgggattcc

SEQ ID NO: 111 - DNA, 16 bp, Saccharomyces cerevisiae complete genome
  (151516)...(151531): Chromosome =   3  Contig =  3  Strand = neg CtronObjNum =    3387
aaaggctataatatta

SEQ ID NO: 112 - DNA, 16 bp, Saccharomyces cerevisiae complete genome
  (82825)...(82840): Chromosome =   3  Contig =  3  Strand = neg CtronObjNum =    2905
aaaggctataatatta

SEQ ID NO: 113 - DNA, 32 bp, Homo sapiens complete genome
  (17572332)...(17572363): Chromosome = 920  Contig = 19  Strand = pos CtronObjNum =  747775
ccagcccctcctccctcagacccaggagtcca

SEQ ID NO: 114 - DNA, 32 bp, Homo sapiens complete genome; identical to SEQ ID NO: 113
  (27988178)...(27988209): Chromosome = 922  Contig = 19  Strand = neg CtronObjNum =  765474

SEQ ID NO: 115 - DNA, 32 bp, Homo sapiens complete genome; identical to SEQ ID NO: 113
  (17572369)...(17572400): Chromosome = 920  Contig = 19  Strand = pos CtronObjNum =  747777

SEQ ID NO: 116 - DNA, 32 bp, Homo sapiens complete genome; identical to SEQ ID NO: 113
  (28004852)...(28004883): Chromosome = 922  Contig = 19  Strand = pos CtronObjNum =  765567

SEQ ID NO: 117 - DNA, 40 bp, Homo sapiens complete genome
  (17573447)...(17573486): Chromosome = 920  Contig = 19  Strand = pos CtronObjNum =  747819
ccccagcccctcctccctcagacccaggagtccagacccc

SEQ ID NO: 118 - DNA, 40 bp, Homo sapiens complete genome; identical to SEQ ID NO: 117
  (27988176)...(27988215): Chromosome = 922  Contig = 19  Strand = neg CtronObjNum =  765474

SEQ ID NO: 119 - DNA, 39 bp, Homo sapiens complete genome
  (17573520)...(17573557): Chromosome = 920  Contig = 19  Strand = pos CtronObjNum =  747823
ggccccagcccctcctccctcagacccaggagtccaggt

SEQ ID NO: 120 - DNA, 39 bp, Homo sapiens complete genome; identical to SEQ ID NO: 119
  (28004848)...(28004887): Chromosome = 922  Contig = 19  Strand = pos CtronObjNum =  765567

(19) United States
(12) Patent Application Publication
(10) Pub. No.: US 2006/0122789 A1
(43) Pub. Date: Jun. 8, 2006

(54) Symmetry relationships between pairs of connectrons

(76) Inventor: Richard J. Feldmann, Derwood, MD (US)

Correspondence Address: Law Office of Jim Zegeer, Suite 108, 801 North Pitt Street, Alexandria, VA, 22314, US

(21) Appl. No.: 10/803,195

(22) Filed: Mar. 18, 2004

Related U.S. Application Data
(63) Continuation-in-part of application No. 09/866,925, filed on May 30, 2001.
(60) Provisional application No. 60/455,563, filed on Mar. 19, 2003.

(30) Foreign Application Priority Data
May 31, 2001 (WO) PCT/US01/16471

(51) Int. Cl. G06F 19/00

(52) U.S. Cl. 702/20

(57) ABSTRACT

The gene expression control properties of many different pairs of connectrons are described in terms of the similarity or disparity of the connectron sources and the symmetry or asymmetry of the resulting pairs of connectrons.

### REFERENCE TO RELATED APPLICATIONS

The present application includes the subject of Provisional Application Ser. No. 60/455,563 filed Mar. 19, 2003

The present application is a continuation in part of U.S. patent application Ser. No. 09/866,925 filed May 30, 2001 entitled ALGORITHMIC DETERMINATION OF FLANKING DNA SEQUENCES THAT CONTROL THE EXPRESSION OF SETS OF GENES IN PROKARYOTIC, ARCHEA AND EUKARYOTIC GENOMES. (referred to as “basic methods patent application”)

This present application is related to PCT application PCT/US01/16471 filed May 31, 2001 and entitled ALGORITHMIC DETERMINATION OF FLANKING DNA SEQUENCES THAT CONTROL THE EXPRESSION OF SETS OF GENES IN PROKARYOTIC, ARCHEA AND EUKARYOTIC GENOMES.

The present application is also related to U.S. patent application Ser. No. 10/339,666 filed Jan. 10, 2003 entitled SIMULATION OF GENE EXPRESSION CONTROL USING CONNECTRONS, INTERFERENCE RNAS (IRNAS) AND SMALL TEMPORAL RNAS (STRNAS) IN PROKARYOTIC, ARCHEA AND EUKARYOTIC GENOMES

The present application is also related to U.S. patent application Ser. No. 10/364,516 filed Feb. 12, 2003 entitled DETERMINATION OF FLANKING DNA SEQUENCES THAT CONTROL THE EXPRESSION OF SETS OF GENES IN THE ESCHERICHIA COLI K-12 MG1655 COMPLETE GENOME

The present application is also related to U.S. patent application Ser. No. 10/364,412 filed Feb. 12, 2003 entitled DETERMINATION OF FLANKING DNA SEQUENCES THAT CONTROL THE EXPRESSION OF SETS OF GENES IN THE SACCHAROMYCES CEREVISIAE COMPLETE GENOME

### INTRODUCTION

The connectron structure of a genome determines sets of four DNA sequences of minimum length of 15-bases (C1 and C2 which are in the 3′ UTR of a gene or pseudogene, and T1 and T2 which bracket a set of genes or pseudogenes). The connectrons in a genome control the expression of sets of genes. This patent application describes new types of connectrons as well as how pairs of equivalent and non-equivalent RNA sequences can bind to double-stranded DNA to form a variety of connectrons.

### DEFINITIONS

Previous definitions of connectron structure are included by reference.
Connectrome—All the connectrons in a given genome.
Dominant Direction—The DNA sequence of a chromosome or a genome from the 5′ end to the 3′ end of the positive strand.
Anti-Dominant Direction—The DNA sequence of a chromosome or a genome from the 5′ end to the 3′ end of the negative strand.
C1/C2 Polarity—The direction of the binding of the RNA of a connectron in the major groove of the double-stranded DNA in the dominant direction or the anti-dominant direction.
Uni-Polar C1/C2—The binding of the RNA of a connectron such that either (1) both the C1 sequence and the C2 sequence bind in the dominant direction or (2) both the C1 sequence and the C2 sequence bind in the anti-dominant direction.
Bi-Polar C1/C2—The binding of the RNA of a connectron such that either (1) the C1 sequence binds in the dominant direction and the C2 sequence binds in the anti-dominant direction or (2) the C1 sequence binds in the anti-dominant direction and the C2 sequence binds in the dominant direction.

Reverse Complement—Going away from a given point, the same sequence occurs on opposite strands. In the example below the sequence GCATCC in the dominant direction of the positive strand occurs somewhere else in the genome in the anti-dominant direction of the negative strand

| | |
|---|---|
| Positive Strand | 5′-GCATCCGTGTAAT ATTACACGGATGC-3′ |
| Negative Strand | 3′-CGTAGGCACATTA TAATGTGCCTACG-5′ |

Equivalent Sequences—Two sequences such that the second sequence is in the reverse complement of the first sequence

| | | |
|---|---|---|
| First sequence | 5′-GCATCCGTGTAAT-3′ | (A) |
| Second sequence | 5′-ATTACACGGATGC-3′ | (A′) |

If the first sequence is called A then the second sequence is called A′
Symmetric Lower-Upper Pair of Connectrons—The binding of two equivalent uni-polar RNA C1/C2 sequence pairs to double-stranded DNA.
Asymmetric Lower-Upper Pair of Connectrons—The binding of two non-equivalent uni-polar RNA C1/C2 sequence pairs to double-stranded DNA.
Symmetric Left-Right Pair of Connectrons—The binding of two equivalent bi-polar RNA C1/C2 sequence pairs to double-stranded DNA.
Asymmetric Left-Right Pair of Connectrons—The binding of two non-equivalent bi-polar RNA C1/C2 sequence pairs to double-stranded DNA.
Connectron Lifetime—A time that varies directly with the length of the shorter of the two triple-stranded generalized Hoogsteen helices formed by the binding of the C1 and C2 RNA connectron sequences to the major groove of the double-stranded DNA.
Connectron Pair Lifetime—A time that varies directly with the product of the lifetimes of the two connectrons in the pair.
Specificity of a Pair of Connectrons—The number of similar or different C1/C2 sources needed to form the pair of connectrons.
Symmetric Connectron Specificity—The specificity of a pair of connectrons formed with equivalent uni-polar or bi-polar RNA sequences.
Asymmetric Connectron Specificity—The specificity of a pair of connectrons formed with non-equivalent uni-polar or bi-polar RNA sequences.
Competitive Mode of Behavior in the Formation of a Connectron Pair—The situation where two different genes produce the same uni-polar or bi-polar C1/C2 sequences of the same or different lengths that bind to the major groove of the double-stranded DNA to form a connectron pair.
Cooperative Mode of Behavior in the Formation of a Connectron Pair—The situation where two different genes produce different uni-polar or bi-polar C1/C2 sequences of the same or different lengths that bind to the major groove of the double-stranded DNA to form a connectron pair such that the connectron pair could only be formed from the two different C1/C2 sequences.

### PRIOR ART

Included by reference.

### BRIEF DESCRIPTION OF THE OBJECTS OF THE INVENTION

The basic methods patent application provides the methods for determining the structure of the connectrons in a variety of prokaryotic, Archeal and eukaryotic genomes.

An object of this invention is to provide a method for identifying a one or more new classs of connectrons that bind to the major groove of double-stranded DNA in two directions.

An object of this invention is to provide a method for designing a new class of connectrons that bind to the major groove of double-stranded DNA in two directions.

An object of this invention is to provide a method for identifying the relationship between a pair of connectrons in a genome.

An object of this invention is to provide a method for designing the relationship between a pair of connectrons in a genome.

An object of this invention is to provide a method for identifying the relationship between an existing pair of connectrons in a genome that act in competitive mode such that with respect to the individual connectrons there is an increased lifetime of connectron control of a set of genes.

An object of this invention is to provide a method for designing a new synthetic pair of connectrons in a genome that act in competitive mode such that with respect to the individual connectrons there is an increased lifetime of connectron control of a set of genes.

An object of this invention is to provide a method for identifying the relationship between an existing pair of connectrons in a genome that act in cooperative mode such that with respect to the individual connectrons there is an increased lifetime of connectron control of a set of genes.

An object of this invention is to provide a method for designing a new synthetic pair of connectrons in a genome that act in cooperative mode such that with respect to the individual connectrons there is an increased lifetime of connectron control of a set of genes.

### DESCRIPTION OF THE DRAWINGS AND TABLES

FIG. 1 Shows how (a) a lower connectron and (b) an upper connectron, form (c) an lower-upper connectron pair

FIG. 2 Shows how (a) a left connectron and (b) a right connectron, form (c) a left-right connectron pair

FIG. 3 Shows (a) a symmetric lower-upper connectron pair, (b) an asymmetric lower-upper connectron pair

FIG. 4 Shows (a) a symmetric left-right connectron pair, (b) an asymmetric left-right connectron pair

FIG. 5 Shows (a) Concise representation of an asymmetric lower-upper connectron pair and (b) detailed representation of a asymmetric lower-upper connectron pair

FIG. 6 Shows (a) Concise representation of an asymmetric left-right connectron pair and (b) detailed representation of a asymmetric left-right connectron pair

FIG. 7 Shows the four variations of symmetric lower-upper connectron pairs—(a) dominant—dominant, (b) anti-dominant—dominant, (c) dominant—anti-dominant, and (d) anti-dominant—dominant

FIG. 8 Shows the four variations of symmetric left-right connectron pairs—(a) dominant—dominant, (b) anti-dominant—dominant, (c) dominant—anti-dominant, and (d) anti-dominant—dominant

FIG. 9 Shows the four variations of asymmetric lower-upper connectron pairs—(a) dominant—dominant, (b) anti-dominant—dominant, (c) dominant—anti-dominant, and (d) anti-dominant—dominant

FIG. 10 Shows the four variations of asymmetric left-right connectron pairs—(a) dominant—dominant, (b) anti-dominant—dominant, (c) dominant—anti-dominant, and (d) anti-dominant—dominant

FIG. 11 Shows (a) the competitive blocking of symmetric lower-upper long-lived connectrons, (b) the competitive blocking of symmetric left-right long-lived connectrons, and (c) the relative timing windows for competitive blocking of symmetric long-lived connectrons

FIG. 12 Shows (a) the competitive blocking of asymmetric lower-upper long-lived connectrons, (b) the competitive blocking of asymmetric lower-upper long-lived connectrons, (c) the competitive blocking of asymmetric left-right long-lived connectrons, and (d) the competitive blocking of asymmetric left-right long-lived connectrons

FIG. 13 Shows (a) the timing windows for competitive blocking of asymmetric long-lived connectrons

FIG. 14 Shows (a) a fully symmetric connectron tetrad, (b) non-competitive blocking effect by a left short-lived connectrons of a long-lived cooperative connectron pair, (c) non-competitive blocking effect by a right short-lived connectrons of a long-lived cooperative connectron pair, and (d) the timing windows for non-competitive blocking of asymmetric long-lived connectrons

### DESCRIPTION OF THE INVENTION

The basic methods patent application for the determination of connectron structure defines the DNA and RNA sequence components that make up a connectron, as well as presenting examples of different sorts of connectrons from many different types of genomes. The computer algorithm presented in that patent application shows how to find connectrons in a particular genome. The genomic patent applications utilize the power of this computer algorithm to determine all of the connectrons in a particular genome. Although the basic methods patent application identifies permanent, transient and one-shot connectrons, the view presented is that of a single connectron. This patent application presents the relationships among pairs of connectrons. This invention will allow us to organize the connectrons in a genome and show how pairs of connectrons work together to produce new gene expression regulation properties. In particular, this invention will allow us to show how different C1/C2 connectron sequences from different gene expression events can cooperate to form a pair of long-lived connectrons. The ability to form very specific and cooperative conjunctive events makes it possible for biological systems to form arbitrarily complex control procedures that may very well be needed for cellular differentiation and the development of a complete multi-celled organism from a single cell.

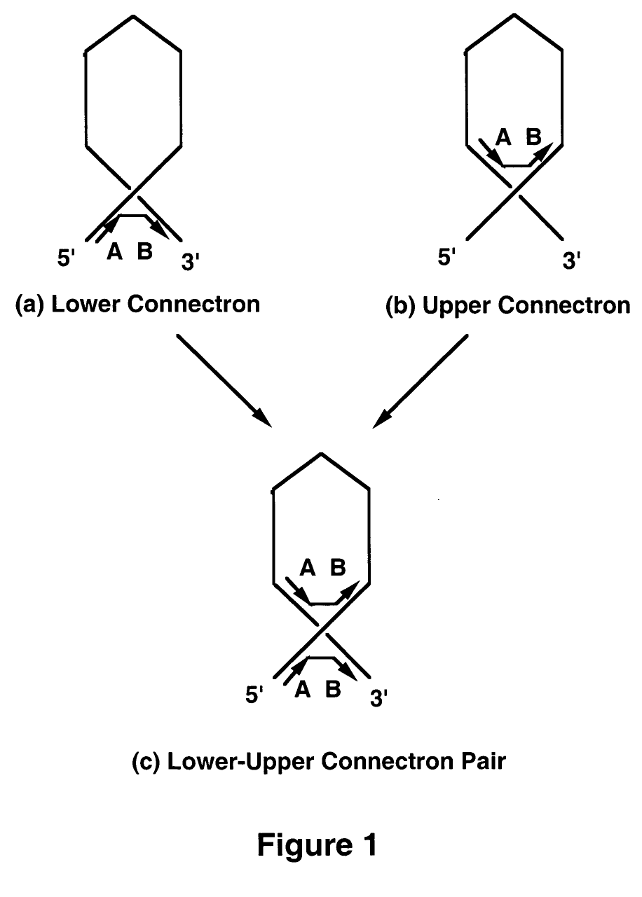

A connectron forms a loop in a piece of double-stranded DNA. As shown in figure la the DNA runs from the 5′ end shown on the lower left in a counter-clockwise direction to the 3′ end shown on the lower right. The RNA generated by the promotion and transcription of some gene or pseudo-gene somewhere in the genome binds to two distinct double-stranded DNA sequences to form two distinct triple-stranded generalized Hoogsteen helices. In figure la the first triple-stranded (generalized Hoogsteen) helix is called A and the second helix is called B. The A helix forms along the major groove of the DNA in the 5′ to 3′ direction. Similarly the B helix in FIG. 1a forms along the major groove of the DNA in the 5′ to 3′ direction. The A-B pair of triple-stranded helices occupy the lower position in the X-shape formed by the loop. Hence in FIG. 1a the connectron is described as a “lower connectron”. In FIG. 1b both the A and B helices form in the 5′ to 3′ direction, but they occupy the upper position in the X-shape formed by the loop. Hence in FIG. 1b the connectron is described as an “upper connectron”. In FIG. 1c the lower and upper connectrons are shown binding simultaneously.

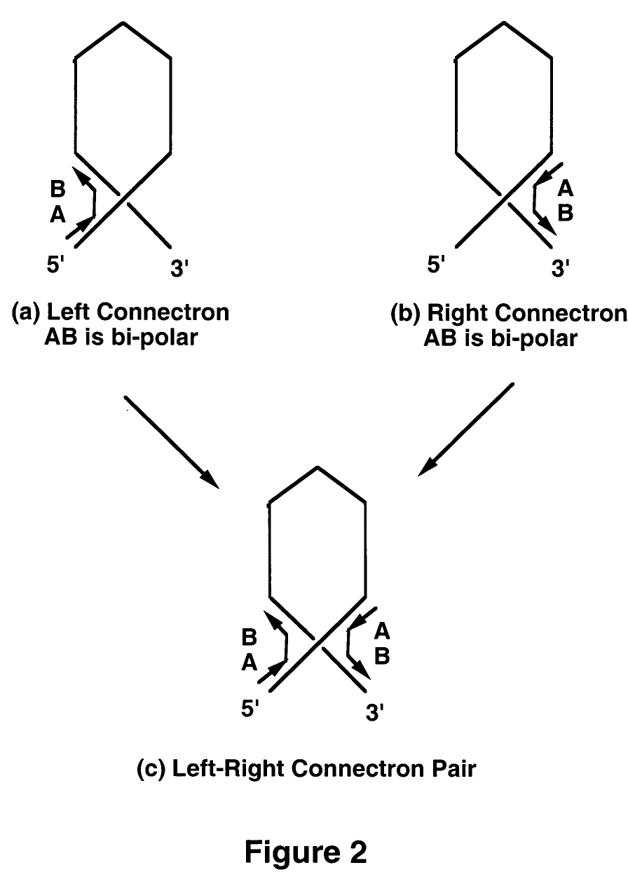

In FIG. 2a the A helix forms along the major groove of the DNA in the 5′ to 3′ direction but the B helix forms along the major groove of the DNA by binding along the major groove of the double helix in the 3′ to 5′ direction. The importance of this connectron is that the RNA switches strands as it moves from A-helix binding to B-helix binding. This is true in all left and right connectrons. The A-B pair of helices in FIG. 2a occupy the left position in the X-shape formed by the loop. Hence in FIG. 2a the connectron is described as a “left connectron”. In FIG. 2b the A triple-strand helix forms along the major groove of the DNA in the 3′ to 5′ direction, so this connectron is given the designation A-B and is described as a “right connectron”. In FIG. 2c the left and right connectrons are shown binding simultaneously.

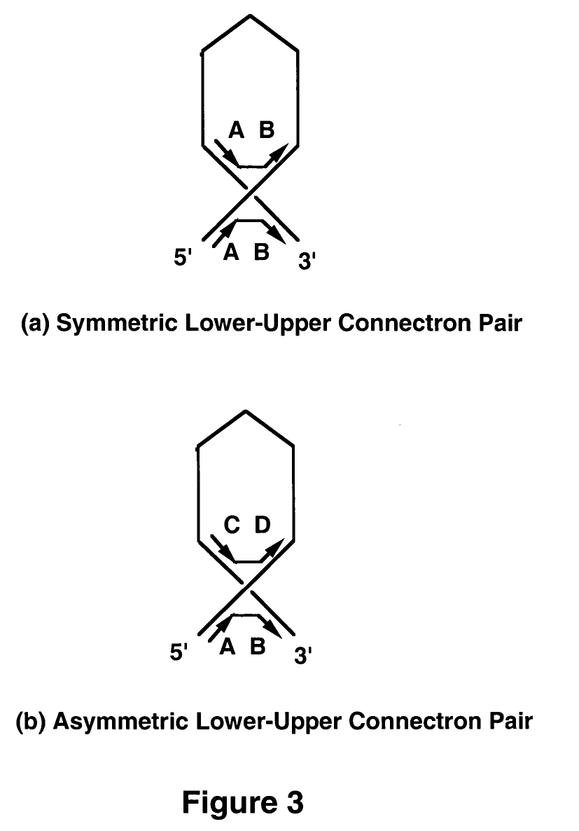

In FIG. 3a the pair of lower and upper connectrons have the same sequences (i.e. A and B) hence this pair of connectrons is called a “symmetric lower-upper connectron pair”. In FIG. 3b the lower connectron has the sequence A-B and the upper connectron has the sequence C-D hence this pair of connectrons is called an “asymmetric lower-upper connectron pair”.

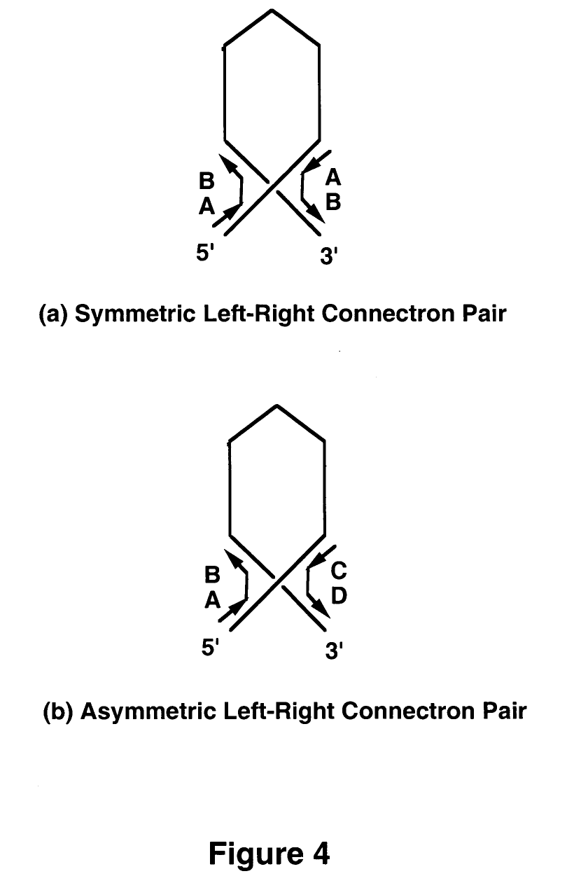

In FIG. 4a the pair of left and right connectrons have the same sequences (i.e. A and B) hence this pair of connectrons is called a “symmetric left-right connectron pair”. In FIG. 4b the left connectron has the sequence A-B and the right connectron has the sequence C-D, where C is not equal to A and/or D is not equal to B hence this pair of connectrons is called an “asymmetric left-right connectron pair”.

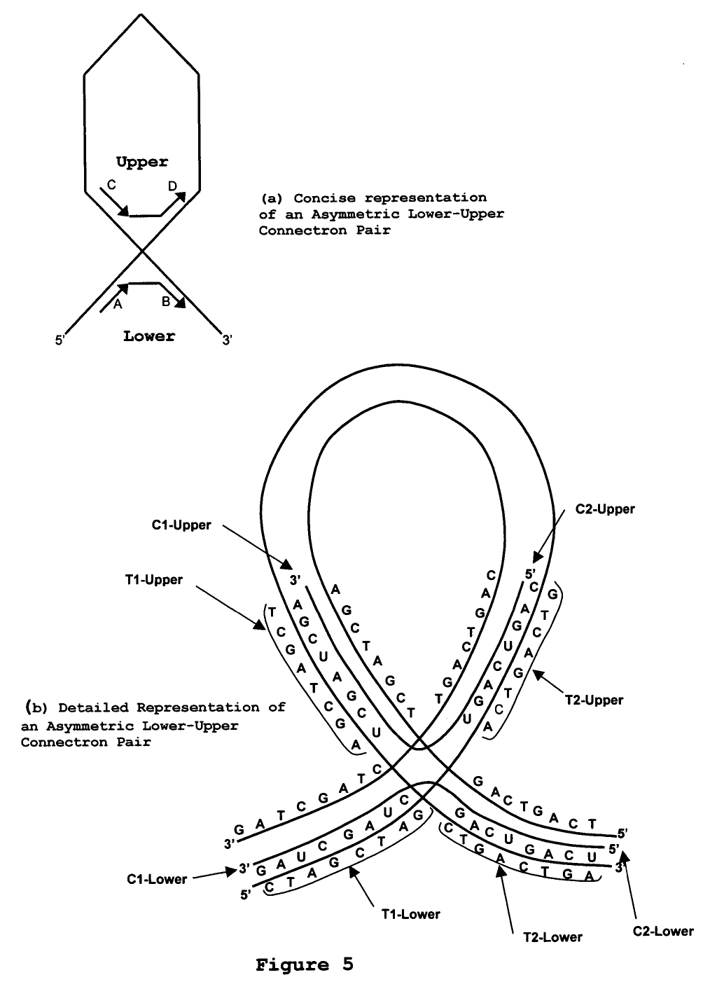

FIG. 5a—a re-statement of FIG. 3b—is a concise representation of an asymmetric lower-upper connectron pair.

FIG. 5b is a detailed representation of the same asymmetric lower-upper connectron pair showing the sequence relationships between the RNA strand and the two DNA strands. The equivalence of the RNA-strand sequence and the 5′ to 3′ DNA-strand sequence means that the RNA-strand sequence will share the hydrogen bonds to the 3′ to 5′ DNA-strand sequence.

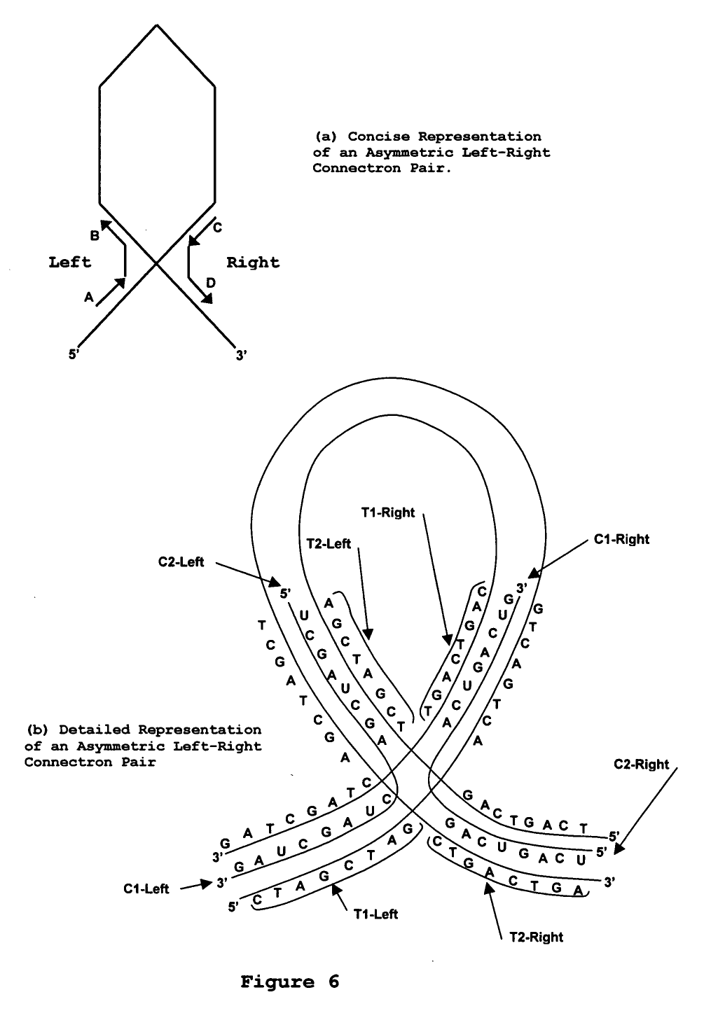

FIG. 6a—a re-statement of FIG. 4b—is a concise representation of an asymmetric left-right connectron pair.

FIG. 6b is a detailed representation of the same asymmetric left-right connectron pair showing the sequence relationships between the RNA strand and the two DNA strands. The equivalence of the RNA-strand sequence and the 5′ to 3′ DNA-strand sequence for the first triple helix of each of these connectrons means that the RNA-strand sequence will share the hydrogen bonds to the 3′ to 5′ DNA-strand sequence. Similarly, the equivalence of the RNA-strand sequence and the 3′ to 5′ DNA-strand sequence for the second triple helix of each of these connectrons means that the RNA-strand sequence will share the hydrogen bonds to the 5′ to 3′ DNA-strand sequence.

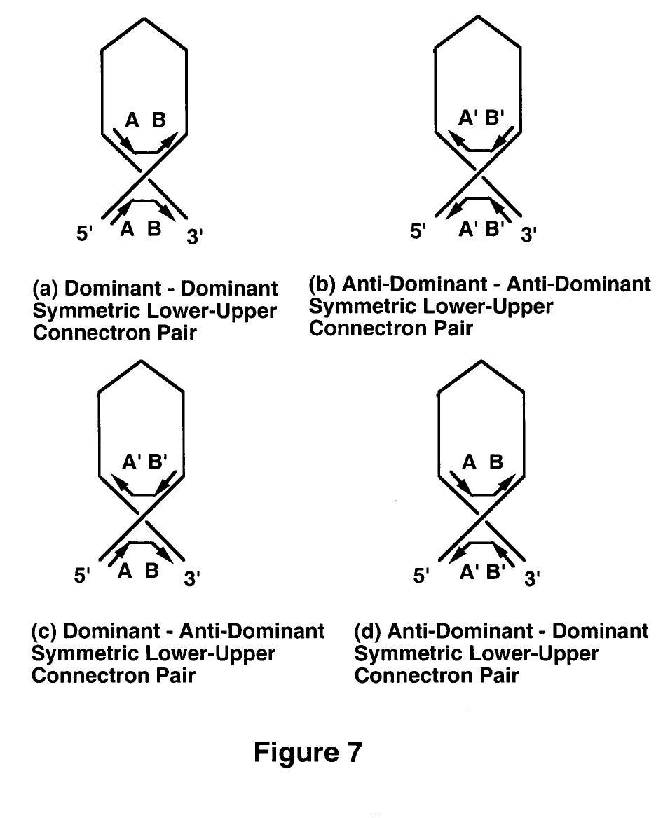

FIG. 7a shows the lower and upper connectrons both binding in the dominant direction with the sequence A-B hence this pair of connectrons is called a “dominant—dominant symmetric lower-upper connectron pair”. FIG. 7b shows the lower and upper connectrons both binding in the anti-dominant direction with the sequence B′-A′ hence this pair of connectrons is called an “anti-dominant—anti-dominant symmetric lower-upper connectron pair”. In FIG. 7c the lower connectron binds in the dominant direction with the sequence A-B and the upper connectron binds in the anti-dominant direction with the sequence B′-A′ hence this pair of connectrons is called a “dominant—anti-dominant symmetric lower-upper connectron pair”. In FIG. 7d the lower connectron binds in the anti-dominant direction with the sequence B′ A′ and the upper connectron binds in the dominant direction with the sequence A-B. In FIG. 7 each of the four sequence pairs is different, hence there are four different types of symmetric lower-upper connectron pairs.

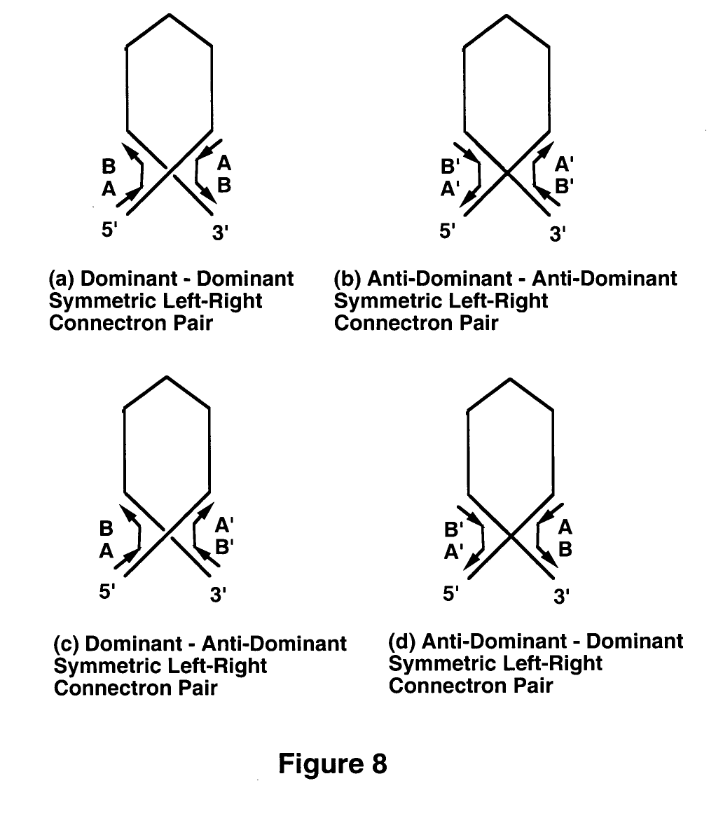

FIG. 8a shows the left and right connectrons both binding in the dominant direction with the sequences A-B hence this pair of connectrons is called a “dominant—dominant symmetric left-right connectron pair”. FIG. 8b shows the lower and upper connectrons both binding in the anti-dominant direction with the sequence B′-A′ hence this pair of connectrons is called an “anti-dominant—anti-dominant symmetric left-right connectron pair”. In FIG. 8c the left connectron binds in the dominant direction with the sequence A-B and the right connectron binds in the anti-dominant direction with the sequence B′-A′ hence this pair of connectrons is called a “dominant—anti-dominant symmetric left-right connectron pair”. In FIG. 8d the left connectron binds in the anti-dominant direction with the sequence B′-A′ and the right connectron binds in the dominant direction with the sequence A-B hence this pair of connectrons is called an “anti-dominant—dominant symmetric left-right connectron pair”. In FIG. 8 each of the four sequence pairs is different, hence there are four different types of symmetric left-right connectron pairs.

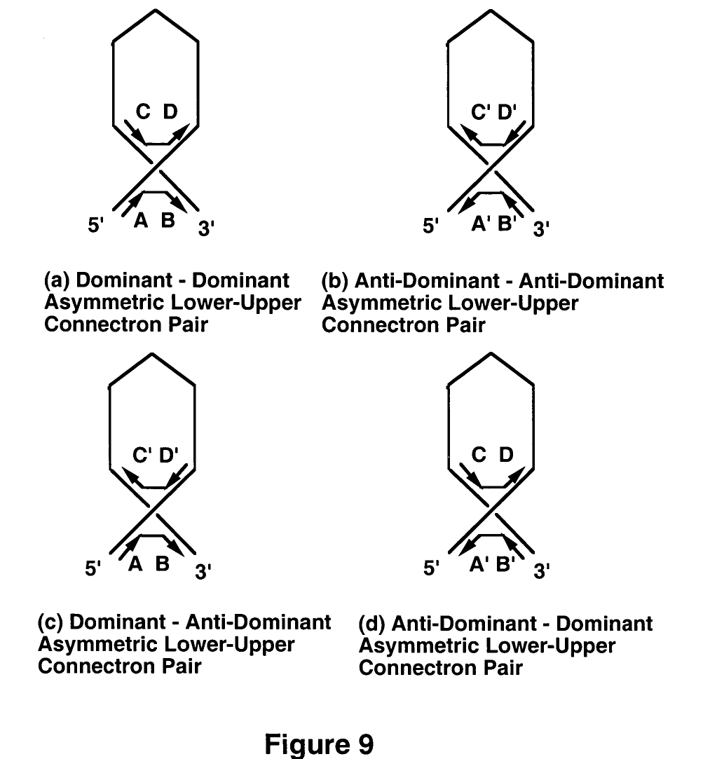

FIG. 9a shows the lower and upper connectrons both binding in the dominant direction but the sequences of the two connectrons are different. The lower connectron has the sequence are A-B and the upper connectron has the sequence C-D hence this pair of connectrons is called a “dominant—dominant asymmetric lower-upper connectron pair”. In FIG. 9b the lower connectron binds in the dominant direction with the sequence B′-A′ and the upper connectron binds in the anti-dominant direction with the sequence D′-C′ hence this pair of connectrons is called an “anti-dominant—anti-dominant asymmetric lower-upper connectron pair”. In FIG. 9c the lower connectron binds in the dominant direction with the sequence A-B and the upper connectron binds in the anti-dominant direction with the sequence D′-C′ hence this pair of connectrons is called a “dominant—anti-dominant asymmetric lower-upper connectron pair”. In FIG. 9d the lower connectron binds in the anti-dominant direction with the sequence B′-A′ and the upper connectron binds in the dominant direction with the sequence C-D hence this pair of connectrons is called an “anti-dominant—dominant asymmetric lower-upper connectron pair”. In FIG. 9 each of the four sequence pairs is different, hence there are four different types of asymmetric lower-upper connectron pairs.

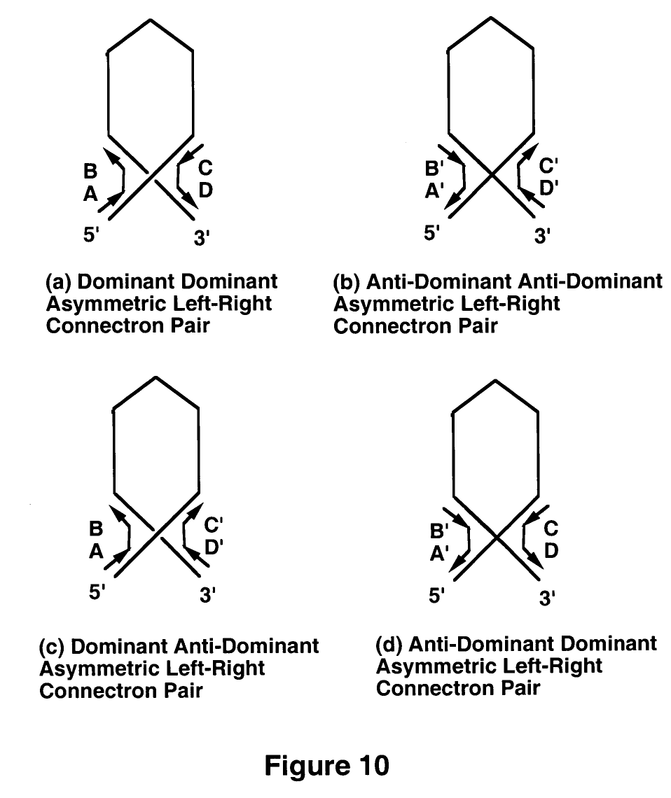

FIG. 10a shows the left and right connectrons both binding in the dominant direction but the sequences of the two connectrons are different. The left connectron has the sequence A-B and the right connectron has the sequence C-D hence this pair of connectrons is called a “dominant—dominant asymmetric left-right connectron pair”. In FIG. 10b the left connectron binds in the anti-dominant direction with the sequence B′-A′ and the right connectron binds in the anti-dominant direction with the sequence D′-C′ hence this pair of connectrons is called an “anti-dominant—anti-dominant asymmetric left-right connectron pair”. In FIG. 10c the left connectron binds in the dominant direction with the sequence A-B and the right connectron binds in the anti-dominant direction with the sequence D′-C′ hence this pair of connectrons is called a “dominant—anti-dominant asymmetric left-right connectron. In FIG. 10d the left connectron binds in the anti-dominant direction with the sequence B′-A′ and the right connectron binds in the dominant direction with the sequence C-D hence this pair of connectrons is called an “anti-dominant—dominant asymmetric left-right connectron. In FIG. 10 each of the four sequence pairs is different, hence there are four different types of asymmetric left-right connectron pairs.

The lifetime of a single connectrons is easy to understand. Consider a single connectron as shown in FIG. 1a. For the sake of example let the A triple-strand (generalized Hoogsteen) helix be the minimum length of 15 bases and let the B triple-strand helix be some long length, for example 100 bases. Remember that the RNA-DNA structure of the connectrons is immersed in a bath of water at 37 degrees Celsius. Thermal motion will cause the A triple-strand helix to dissolve into the RNA and DNA components much more rapidly than the much longer B triple-strand helix, so the lifetime of the connectrons varies directly with the length of the shorter of the two triple-strand helices. If the length of the A and B helices are the same then the lifetime of the connectron varies directly with the length of either helix.

Now think about the lifetime of a pair of connectrons as shown in FIG. 1c. For the sake of simplicity, assume that the A and B helices are the same length. In order for the loop to open up, at least one lower helix and one upper helix has to dissolve at the same time. Either or both of the two lower helices can dissolve at the same time but as long as the upper pair of helices is not dissolved, the loop will stay closed. The same is true for the reverse—either of both of the two upper helices can dissolve at the same time but as long as the two lower helices stay intact, the loop stays closed. Physical chemistry is replete with two-part binding events like this. The general description of such events is that the lifetime varies directly with the product of the two binding energies. In the case of a pair of lower-upper connectrons, the lifetime varies directly as the product of the shorter of the lower helices and the shorter of the upper helices. Of course, the same thing is true for the left-right connectron pairs shown in FIG. 2c.

Whatever the binding energy of an RNA strand is with respect to its cognate double-stranded DNA sequence, whenever a sequence pair (for example A-B or B′-A′ ) can form a pair of connectrons, the binding energy of the pair of connectrons is the product of the binding energy of the each connectron. When two different sequence pairs (for example A-B and B′-A′ as shown in FIG. 7) form a pair of connectrons then the pair of connectrons can be formed as one of the four following combinations

| | |
|---|---|
| lower (A-B) | and upper (A-B) |
| lower (B′-A′) | and upper (B′-A′) |
| lower (A-B) | and upper (B′-A′) |
| lower (B′-A′) | and upper (A-B) |

In principle, A-B and B′-A′ could be produced by the expression of two different genes. Because the pair of connectrons can form in four different ways, the two genes causing the production of the two different RNAs are competing for control of the formation of the connectron pair.

The left-right connectron pairs in FIG. 8 have the same properties as the lower-upper connectron pairs in FIG. 7. In principle, A-B and B′-A′ could be produced by the expression of two different genes. Because the pair of connectrons can form in four different ways, the two genes causing the production of the two different RNAs are competing for control of the formation of the connectron pair.

When two different sequence pairs (for example A-B and C-D) form a pair of connectrons then the pair of connectrons can be formed in only one way as shown in FIG. 9a. A-B and C-D can be produced by the expression of two different genes. Because the pair of connectrons can form in only one way, the two genes causing the production of the two different RNAs are cooperating for control of the formation of the connectron pair. The same cooperative behavior is also true of the sequence combinations in FIGS. 9b, 9c and 9d.

Like FIGS. 7 and 8 (that describe symmetric connectron pairs), FIGS. 9 and 10 (that describe asymmetric connectron pairs) share the same properties. When two different sequence pairs (for example A-B and C-D) form a pair of connectrons then the pair of connectrons can be formed in only one way as shown in FIG. 10a. A-B and C-D can be produced by the expression of two different genes. Because the pair of connectrons can form in only one way, the two genes causing the production of the two different RNAs are cooperating for control of the formation of the connectron pair. The same cooperative behavior is also true of the sequence combinations in FIG. 10b, 10c and 10d.

In FIGS. 7 and 8 (that describe symmetric connectron pairs) the connectron pair constructs produce competition whereas in FIGS. 9 and 10 (that describe asymmetric connectron pairs) the connectron pair constructs produce cooperation. FIGS. 7 and 8 are symmetric constructs whereas FIGS. 9 and 10 are asymmetric constructs.

Whereas in FIG. 7 the sequence along the DNA the X-shape of the crossing (i.e. either the/sequence or the\sequence) is the sequence A-B, in FIG. 8 the same elements are reverse-complements.

The algorithm described in the basic methods patent application finds all of the uni-polar the connectrons in a genome. This patent application describes connectrons in terms of their symmetry properties (i.e. uni-polar, bi-polar, lower, upper, left, right, symmetric, asymmetric). The original algorithm has been modified and the connectron structure of the genomes recomputed to find both the uni-polar and bi-polar connectrons. The modification of the basic connectron determination algorithm to identify the left-right connectrons required only a half dozen lines of code change which is at or below the level of resolution of the flow charts presented in the basic methods patent application. The utility of this patent application is that we have shown that pairs of connectrons both compete and cooperate by forming in the same place (i.e. the X-shaped loop interaction region) to produce lifetimes that vary directly with the product of the lifetimes of the individual connectrons.

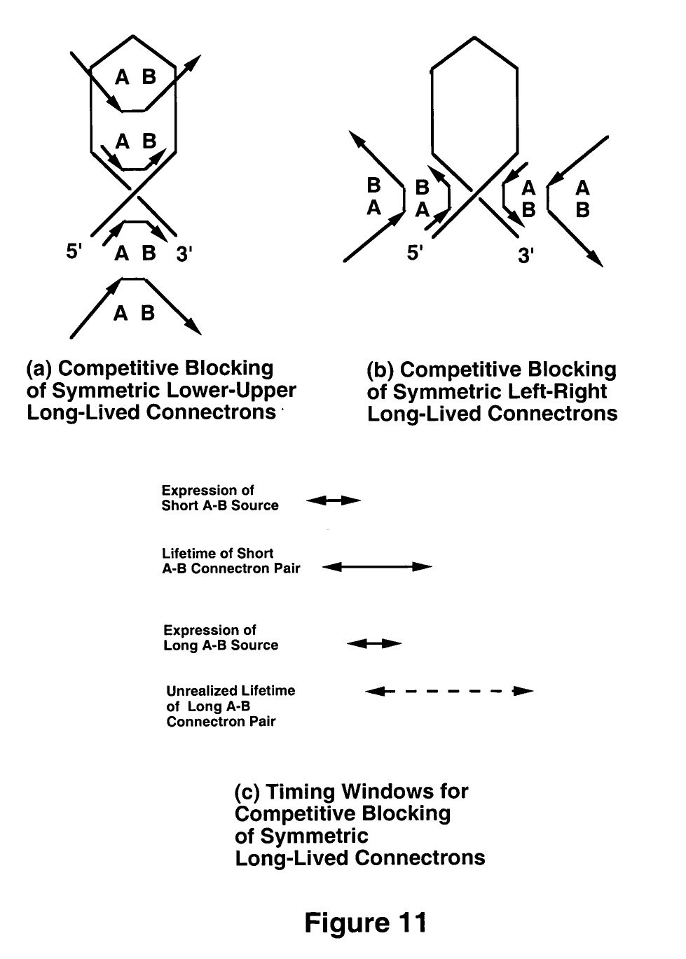

FIG. 11a shows how one source (A-B) of the C1/C2 RNA that forms a lower-upper connectron pair with a relatively short product lifetime can temporally compete with another source of a much longer C1/C2 RNA which could form a much longer-lived symmetric connectron pair. FIG. 11b shows how one source (A-B) of the C1/C2 RNA that forms a left-right connectron pair with a relatively short product lifetime can temporally compete with another source of a much longer C1/C2 RNA which could form a much longer-lived symmetric connectron pair. As shown in FIG. 11c, the shorter A-B connectron pair only has to last throughout the expression window of the longer connectron pair in order to prevent the longer-lived connectron pair from forming. After the short-lived A-B connectron pair expires, the loop is effectively open.

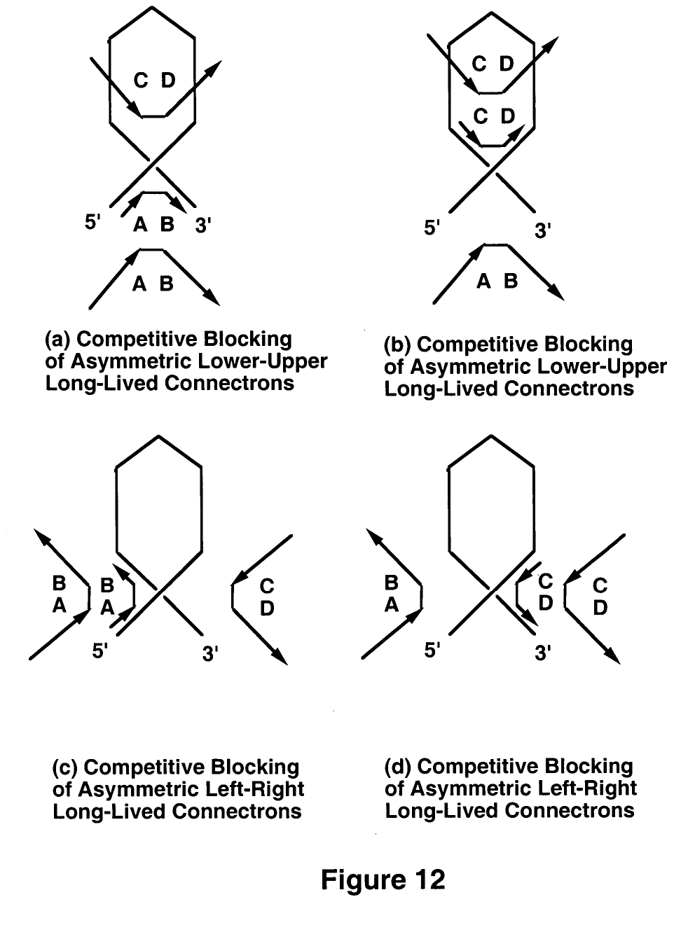

FIG. 12a shows how a short-lived lower connectron can block the formation of a much longer-lived asymmetric connectron pair. FIG. 12b shows how a short-lived upper connectron can block the formation of a much longer-lived asymmetric connectron pair. FIG. 12c shows how a short-lived left connectron can block the formation of a much longer-lived asymmetric connectron pair. FIG. 12d shows how a short-lived right connectron can block the formation of a much longer-lived asymmetric connectron pair.

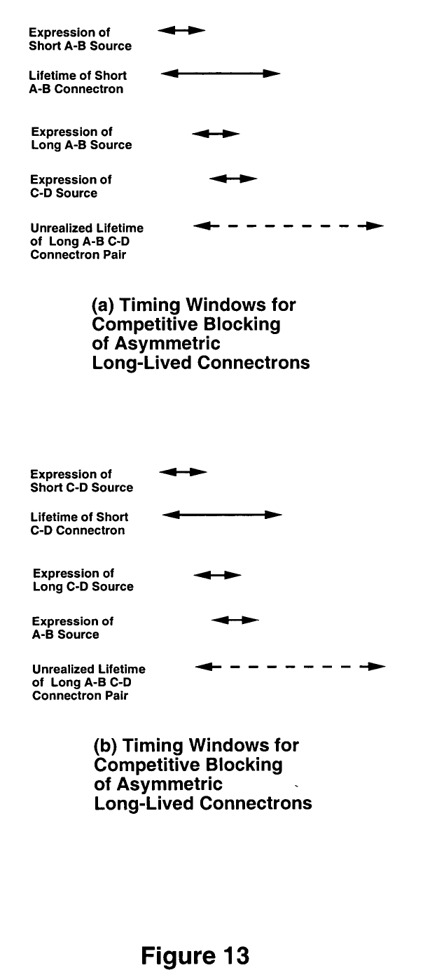

FIG. 13a shows the timing windows for the competitive blocking of an asymmetric long-lived connectron pairs as shown in FIGS. 12a and 12c. FIG. 13b shows the timing windows for the competitive blocking of an asymmetric long-lived connectron pair pairs as shown in FIGS. 12b and 12d.

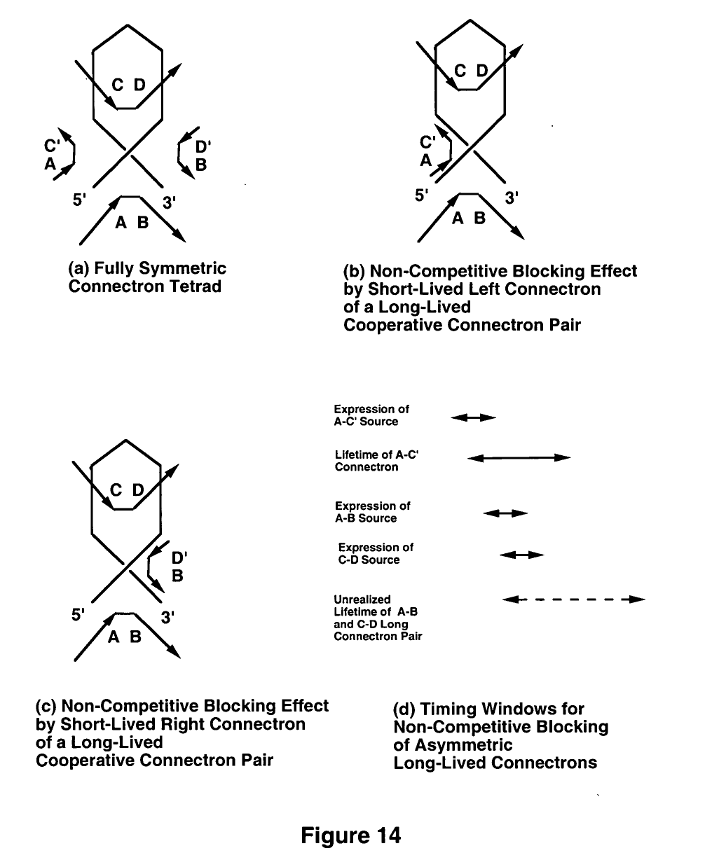

FIG. 14a shows how, in-principle, four connectrons could form at a given site. Clearly not all four of these connectrons can form at this site at the same time because each connectron occupies two of the four target (T1 or T2) sites. The lower A-B and upper C-D pair can form at the same time or the left A-C′ and right D′-B pair can form at the same time. FIG. 14b shows how a short-lived left connectron A-C′ can block the formation of a much longer-lived cooperative connectron pair A-B and C-D. FIG. 14c shows how a short-lived right connectron D′-B can block the formation of a much longer-lived cooperative connectron pair A-B and C-D. FIG. 14d shows the timing chart for this type of temporal blocking. FIGS. 11c, 13a and 14d show three distinctly different types of temporal blocking. To someone skilled in the art it would be obvious that it does not matter whether the lower-upper or left-right connectrons are used for either the blocking or blocked connectrons—as long as the relative patterns are maintained.

The utility of the connectron pairs shown in FIGS. 1 to 14 is that they form the primitives of a language that can build arbitrarily large and complex patterns of structural and temporal connectron control of gene expression. These language primitives can be used to analyze patterns of connectron control of gene expression in all types of genomes (i.e. prokaryotic, Archeal and eukaryotic). These language primitives can also be used to create new patterns of connectron control of gene expression in all types of genomes. These same primitives will help us to understand how cells differentiate from each other in terms of their gene expression and how a single cell develops into a complete organism.

Although FIGS. 1 to 14 function in the first instance to describe the relationships between the control sequences (i.e. the C1s and C2s) produced by the same or different gene expressions and the target sequences (i.e. the T1s and the T2s) in a pair of connectrons, these same figures can also function as the basis for the design of new synthetic pairs of connectrons. For example, the target sequences (A-B) that form the symmetric connectron pair shown in FIG. 3a could be modified by changing the upper connectron Tl sequence from A to C and the upper connectron T2 sequence from B to D to form the asymmetric connectron pair shown in FIG. 3b. The C1/C2 sequences C-D could then be inserted in the 3′ UTR of some gene so the A-B and C-D connectron pair would be formed only when two genes expressed. This modification of the upper connectron sequences is an example of how all the connectron pair properties in FIGS. 1 to 14 could be instantiated either by de-novo sequence placement or by partial modification of existing sequences and relationships. Anyone skilled in the art should be able to convert the descriptions of connectron-pair properties in FIGS. 1 to 14 into design specifications thereby opening up the control of gene expression to a whole range of new possibilities.

The utility of pairs of connectrons (a) whether existing or designed or (b) whether competitive or cooperative is that the lifetime of a single connectron whether it is short or long is multiplied by the existence of an adjacent connectron of similar or different lifetime properties. While the product of the lifetimes of two 15-base connectrons is a modest 225, the product of the lifetimes of two 100-base connectrons would provide an impressive 10,000. Long-lived connectron pairs provide the possibility of turning off a set of genes for extended periods of time. In the examples that follow, Nature has used sequence matches that vary in this range.

### EXAMPLES

FIGS. 1 to 14 provide a large number of ways of describing and designing connectron pairs in a genome. We give examples of the description of symmetric and asymmetric connectron pairs in six classes of genomes (prokaryotic, Archeal, single-celled eukaryotic, multi-celled eukaryotic, mammalian and plant). We also give two examples of the design of an asymmetric connectron pair in a single-celled eukaryote and a mammal. It is clear that many other variations of symmetric and asymmetric connectron pairs could be described or designed by someone skilled in the art.

Description of a Symmetric Lower-Upper Connectron Pair in E. Coli

E. coli is a prokaryotic organism. A single connectron has been selected from the E. coli connectrome to illustrate the properties of a lower-upper connectron pair. Because the connectron is very long it can be split into two connectrons that then bind as a pair. In this and each of the following examples, a header indicates the function of each data field. Because of print-page limitations, the “sequence of match” field has been moved to the left side of each example.

The connectron 1434 has a C1-T1 binding length of 182 bases and a C2-T2 binding length of 171 bases. The shorter of the two matches of 171 bases is then halved with the first half becoming the A and the second half becoming the B in FIG. 3a producing a producted connectron pair lifetime of 7225.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | CP = control element on positive strand | | | | | |
| \| | \| | \| | \| | \| | CN = control element on negative strand | | | | | |
| \| | \| | \| | \| | \| | TP = target element on positive strand | | | | | |
| \| | \| | \| | \| | \| | TN = target element on negative strand | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | l/u = lower/upper | | |
| \| | \| | \| | \| | \| | \| | \| | \| | l/r = left/right | | |
| \| | \| | \| | \| | \| | \| | \| | \| | \| | source of Connection | |
| \| | \| | \| | \| | \| | \| | \| | \| | \| | g = gene | |
| \| | \| | \| | \| | \| | \| | \| | \| | \| | p = pseudogene | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |

| eco | 1434 | 1 | 1 | 7435 | CP | 4505.026 | 4505.207 | l/u | g | 182 |
|---|---|---|---|---|---|---|---|---|---|---|
| CTGTAGATTCAATCTGTCAATGCAACACCCCTTTCAATTATCTCTTTCGG | | | | | | | | | | |
| TGTTTTGAACTTCAGTGTCTTTCTCGGTCTGTTGTTTAGCTGAGCAGCAA | | | | | | | | | | |
| CCACATCTAGTTCATGTTGAGTATATTGGGCAAGACATGTCTTTTTAGGA | | | | | | | | | | |
| AAGTACTGCCGAATTAGCCCATTTGTGTTCTC | | | | | | | | | | |
| eco | 1434 | 1 | 1 | 508 | TN | 279.155 | 279.336 | l/u | g | 182 |
| CTGTAGATTCAATCTGTCAATGCAACACCCCTTTCAATTATCTCTTTCGG | | | | | | | | | | |
| TGTTTTGAACTTCAGTGTCTTTCTCGGTCTGTTCTTTAGCTGAGCAGCAA | | | | | | | | | | |
| CCAGATCTAGTTCATGTTGAGTATATTGGGCAAGACATGTCTTTTTAGGA | | | | | | | | | | |
| AAGTACTGCCGAATTAGCCCATTTGTGTTCTC | | | | | | | | | | |
| eco | 1434 | 1 | 1 | 7435 | CP | 4505.031 | 4505.201 | l/u | g | 171 |
| GATTCAATCTGTCAATGCAACACCCCTTTCAATTATCTCTTTCGGTGTTT | | | | | | | | | | |
| TGAACTTCAGTGTCTTTCTCGGTCTGTTGTTTAGCTGAGCAGCAACCAGA | | | | | | | | | | |
| TCTAGTTCATGTTGAGTATATTGGGCAAGACATGTCTTTTTAGGAAAGTA | | | | | | | | | | |
| CTGCCGAATTAGCCCATTTGT | | | | | | | | | | |
| eco | 1434 | 1 | 1 | 472 | TN | 270.811 | 270.981 | l/u | g | 171 |

| GATTCAATCTGTCAATGCAACACCCCTTTCAATTATCTCTTTCGGTGTTT | |
|---|---|
| TGAACTTCAGTGTCTTTCTCCGTCTGTTGTTTAGCTGAGCAGCAACCAGA | |
| TCTAGTTCATGTTGAGTATATTGGGCAACACATGTCTTTTTACGAAAGTA | |
| CTGCCGAATTAGCCCATTTGT | |
| Can form an AB symmetric pair of l/u Connectrons with a | |
| lifetime = 85 × 85 = 7225 | |
| | 171 |
| GATTCAATCTGTCAATGCAACACCCCTTTCAATTATCTCTTTCGGTGTTT | |
| TGAACTTCAGTGTCTTTCTCGGTCTGTTGTTTAGCTGAGCAGCAACCAGA | |
| TCTAGTTCATCTTGAGTATATTCGGCAAGACATGTCTTTTTAGGAAAGTA | |
| CTGCCGAATTAGCCCATTTGT | |
| | 171 |

| GATTCAATCTGTCAATGCAACACCCCTTTCAATTATCTCTTTCGGTGTTT | | | | | | | | |
|---|---|---|---|---|---|---|---|---|
| TGAACTTCAGTGTCTTTCTCGGTCTGTTGTTTAGCTGACCAGCAACCAGA | | | | | | | | |
| TCTACTTCATCTTGAGTATATTGGGCAAGACATGTCTTTTTAGGAAAGTA | | | | | | | | |
| CTGCCGAATTAGCCCATTTGT | | | | | | | | |
| 279.155 | 279.239 | 279.252 | 279.336 | --- | 270.811 | 270.895 | 270.897 | 270.981 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Description of a Symmetric Lower-Upper Connectron Pair in S. tokodaii

S. tokodaii is a Archeal organism. In this and the following examples, the header does not show all the cases for a given data field.

The connectron 4240 has a C1-T1 binding length of 67 bases and a C2-T2 binding length of 85 bases. The effective match of 52 bases is then halved with the first half becoming the A and the second half becoming the B in FIG. 3a producing a producted connectron pair lifetime of 676.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| sto | 4240 | 1 | 1 | 3986 | CN | 1178.996 | 1179.062 | l/u | g | 67 |
| TGTACCCCCTTCAAGTAAGCCTCATTTAAGGGAGTTTTCTCCCTTGAATA | | | | | | | | | | |
| AACTACCGGGTACATGA | | | | | | | | | | |
| sto | 4240 | 1 | 1 | 447 | TP | 61.903 | 61.969 | l/u | g | 67 |
| TGTACCCCCTTCAAGTAAGCCTCATTTAAGGGAGTTTTCTCCCTTGAATA | | | | | | | | | | |
| AACTACCGGGTACATGA | | | | | | | | | | |
| sto | 4240 | 1 | 1 | 3986 | CN | 1178.963 | 1179.047 | l/u | g | 85 |
| TTGTAATATTATATCAGTTTACTTCTAATATACTGTACCCCCTTCAAGTA | | | | | | | | | | |
| AGCCTCATTTAAGGGAGTTTTCTCCCTTGAATAAA | | | | | | | | | | |
| sto | 4240 | 1 | 1 | 646 | TP | 123.599 | 123.683 | l/u | g | 85 |

| TTGTAATATTATATCAGTTTACTTCTAATATACTGTACCCCCTTCAAGTA | |
|---|---|
| AGCCTCATTTAAGGGAGTTTTCTCCCTTGAATAAA | |
| Can form an AB symmetric pair of l/u Connectrons with a | |
| lifetime = 26 × 26 = 676 | |
| | 52 |
| TGTACCCCCTTCAAGTAAGCCTCATTTAAGGGAGTTTTCTCCCTTGAATA | |
| AA | |
| | 52 |

| TGTACCCCCTTCAAGTAAGCCTCATTTAAGGGAGTTTTCTCCCTTGAATA | | | | | | | | |
|---|---|---|---|---|---|---|---|---|
| AA | | | | | | | | |
| 61.903 | 61.928 | 61.944 | 61.969 | --- | 123.599 | 123.624 | 123.658 | 123.683 |

```
                      .-----.
                    /  \
                  /  \
    61.903 *  *123.683
                  \ /
                    \\ / /
                      \\ / /
          61.928  *.* 123.6587
                          \ /
                            X
                        /  \
        123.624*  .  * 61.944
                    /  /  \ \
                  /  /  \ \
                /  \
123.599* * 61.969
            /  \
```

Description of a Symmetric Lower-Upper Connectron Pair in S. cerevisiae

The connectron 385 has a C1-T1 binding length of 117 and a C2-T2 binding length also of 117 bases. Since the two matches are equal, the 117 bases are then halved with the first half becoming the A and the second half becoming the B in FIG. 3a producing a producted connectron pair lifetime of 3364.

S. cerevisiae is a single-celled eukaryotic organism.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| yst | 385 | 15 | 15 | 28455 | CP | 975.950 | 976.066 | l/u | g | 117 |

| TTACTAGTATATTATCATATACGGTGTTAGAAGATGACGCAAATGATGAG | | | | | | | | | | |
|---|---|---|---|---|---|---|---|---|---|---|
| AAATAGTCATCTAAATTAGTGGAAGCTGAAACGCAAGGATTGATAATGTA | | | | | | | | | | |
| ATAGGATCAATGAATAT | | | | | | | | | | |
| yst | 385 | 1 | 1 | 419 | TN | 165.888 | 166.004 | l/u | g | 117 |
| TTACTAGTATATTATCATATACGCTGTTAGAAGATGACGCAAATGATGAG | | | | | | | | | | |
| AAATAGTCATCTAAATTAGTGGAAGCTGAAACGCAAGGATTGATAATGTA | | | | | | | | | | |
| ATAGGATCAATGAATAT | | | | | | | | | | |
| yst | 385 | 15 | 15 | 28455 | CP | 975.950 | 976.066 | l/u | g | 117 |
| TTACTAGTATATTATCATATACGGTGTTAGAAGATGACGCAAATGATGAG | | | | | | | | | | |
| AAATAGTCATCTAAATTAGTGGAAGCTGAAACGCAACGATTGATAATGTA | | | | | | | | | | |
| ATAGGATCAATGAATAT | | | | | | | | | | |
| yst | 385 | 1 | 1 | 355 | TN | 160.257 | 160.373 | l/u | g | 117 |

| TTACTAGTATATTATCATATACGGTGTTAGAAGATGACGCAAATGATGAG | |
|---|---|
| AAATAGTCATCTAAATTAGTGGAAGCTGAAACGCAAGGATTGATAATGTA | |
| ATAGGATCAATGAATAT | |
| Can form an AB symmetric pair of l/u Connectrons with a | |
| lifetime = 58 × 58 = 3364 | |
| | 117 |
| TTACTAGTATATTATCATATACGGTGTTAGAAGATGACGCAAATGATGAG | |
| AAATAGTCATCTAAATTAGTGGAAGCTGAAACGCAAGGATTGATAATGTA | |
| ATAGGATCAATGAATAT | |
| | 117 |

| TTACTAGTATATTATCATATACGGTGTTAGAAGATGACGCAAATGATGAG | | | | | | | | |
|---|---|---|---|---|---|---|---|---|
| AAATAGTCATCTAAATTAGTGGAACCTGAAACGCAAGGATTGATAATGTA | | | | | | | | |
| ATAGGATCAATGAATAT | | | | | | | | |
| 165.888 | 165.945 | 165.947 | 166.004 | --- | 160.257 | 160.314 | 160.316 | 160.373 |

```
                      .-----.
                    /  \
                  /  \
  165.888 *  *160.3731
                  \ /
                    \\ / /
                      \\ / /
        165.945  *.* 160.316
                          \ /
                            X
                        /  \
        160.314*  .  *165.947
                    /  /  \ \
                  /  /  \ \
                /  \
160.257* *166.004
            /  \
```

Description of a Symmetric Lower-Upper Connectron Pair in C. elegans

C. elegans is a 1,000-celled eukaryotic organism.

The connectron 55 has a C1-T1 binding length of 68 and a C2-T2 binding length also of 68 bases. The effective match of 43 bases is then halved with the first half becoming the A and the second half becoming the B in FIG. 3a producing a producted connectron pair lifetime of 441.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| wrm | 55 | 1 | 1 | 380 | CN | 221.205 | 221.272 | l/u | g | 68 |
| GGGAATTGCTTCGTCAAATGATCGACGGAGGGCTTTTGGCCATCTGCAAG | | | | | | | | | | |
| GATAAACTCGCATGTCGA | | | | | | | | | | |
| wrm | 55 | 1 | 1 | 433 | TN | 250.979 | 251.046 | l/u | g | 68 |
| GGGAATTGCTTCGTCAAATGATCGACGGAGGGCTTTTGGCCATCTGCAAG | | | | | | | | | | |
| GATAAACTCGCATGTCGA | | | | | | | | | | |
| wrm | 55 | 1 | 1 | 380 | CN | 221.180 | 221.247 | l/u | g | 68 |
| GAGCTCGCAACACCGGCCGAGCAGCGGGAATTGCTTCGTCAAATGATCGA | | | | | | | | | | |
| CGGAGGGCTTTTGGCCAT | | | | | | | | | | |
| wrm | 55 | 1 | 1 | 354 | TN | 214.904 | 214.971 | l/u | g | 68 |

| GAGCTCGCAACACCGGCCGAGCAGCGGGAATTGCTTCGTCAAATGATCGA | |
|---|---|
| CGGAGGGCTTTTGGCCAT | |
| Can form an AB symmetric pair of l/u Connectrons with a | |
| lifetime = 21 × 21 = 441 | |
| | 43 |
| GGGAATTGCTTCGTCAAATGATCGACGGAGGGCTTTTGGCCAT | |
| | 43 |

| GGGAATTGCTTCGTCAAATGATCGACGGAGGGCTTTTGGCCAT | | | | | | | | |
|---|---|---|---|---|---|---|---|---|
| 250.979 | 250.999 | 251.026 | 251.046 | --- | 214.904 | 214.924 | 214.951 | 214.971 |

```
                      .-----.
                    /  \
                  /  \
  279.155 *  *270.981
                  \ /
                    \\ / /
                      \\ / /
        279.239  *.* 270.897
                        \ /
                              X
                        /  \
        270.895*  .  *279.252
                    /  /  \ \
                  /  /  \ \
                /  \
270.811* *279.336
            /  \
```

Description of a Symmetric Lower-Upper Connectron Pair in H. sapiens

H. sapiens is a multi-celled eukaryotic organism—a mammal.

The connectron 1211 has a C1-T1 binding length of 58 bases and a C2-T2 binding length also of 58 bases. Since the two matches are equal, 58 is then halved with the first half becoming the A and the second half becoming the B in FIG. 3a producing a producted connectron pair lifetime of 841.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| hsd | 1211 | 4 | 1 | 1331 | CP | 16.381 | 16.438 | l/u | g | 58 |
| GGTGAGTACCTTTCTATGAAGGTGATAAGGATCCACTGAGTCTTCCATAT | | | | | | | | | | |
| AAAGATCA | | | | | | | | | | |
| hsd | 1211 | 4 | 1 | 1542 | TP | 500.217 | 500.274 | l/u | g | 58 |
| GGTGAGTACCTTTCTATGAAGGTGATAAGGATCCACTGAGTCTTCCATAT | | | | | | | | | | |
| AAAGATCA | | | | | | | | | | |
| hsd | 1211 | 4 | 1 | 1331 | CP | 16.381 | 16.438 | l/u | g | 58 |
| GGTGAGTACCTTTCTATGAAGGTGATAAGGATCCACTGAGTCTTCCATAT | | | | | | | | | | |
| AAAGATCA | | | | | | | | | | |
| hsd | 1211 | 4 | 1 | 1559 | TP | 504.937 | 504.994 | l/u | g | 58 |

| GGTGAGTACCTTTCTATGAAGGTGATAAGGATCCACTGAGTCTTCCATAT | |
|---|---|
| AAAGATCA | |
| Can form an AB symmetric pair of l/u Connectrons with a | |
| lifetime = 29 × 29 = 841 | |
| | 58 |
| GGTGAGTACCTTTCTATGAAGGTGATAAGGATCCACTGAGTCTTCCATAT | |
| AAAGATCA | |
| | 58 |

| GGTGAGTACCTTTCTATGAAGGTGATAAGGATCCACTGAGTCTTCCATAT | | | | | | | | |
|---|---|---|---|---|---|---|---|---|
| AAAGATCA | | | | | | | | |
| 500.217 | 500.245 | 500.246 | 500.274 | --- | 504.937 | 504.965 | 504.966 | 504.994 |

```
                      .-----.
                    /  \
                  /  \
  279.155 *  *270.981
                  \ /
                    \\ / /
                      \\ / /
        279.239  *.* 270.897
                        \ /
                              X
                        /  \
        270.895*  .  *279.252
                    /  /  \ \
                  /  /  \ \
                /  \
270.811* *279.336
            /  \
```

Description of a Symmetric Lower-Upper Connectron Pair in A. thaliana

A. thaliana is a multi-celled eukaryotic organism—a plant.

The connectron 3 has a C1-T1 binding length of 94 bases and a C2-T2 binding length of 79 bases. The shorter of the two matches of 79 bases is then halved with the first half becoming the A and the second half becoming the B in FIG. 5a producing a producted connectron pair lifetime of 1521.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| ath | 3 | 5 | 1 | 29822 | CN | 21590.870 | 21590.960 | l/u | g | 94 |
| TGTTGAAAGTTAAACTTGATTTTGAATCAAGTTTAATTATTGGATCAATT | | | | | | | | | | |
| ATCCAATAATTAATTATGGCCAAATCCAAGTTCTAGAGTTTTCT | | | | | | | | | | |
| ath | 3 | 1 | 1 | 7951 | TP | 3780.765 | 3780.858 | l/u | g | 94 |
| TGTTGAAAGTTAAACTTGATTTTGAATCAAGTTTAATTATTGGATCAATT | | | | | | | | | | |
| ATCCAATAATTAATTATGGCCAAATCCAAGTTCTAGAGTTTTCT | | | | | | | | | | |
| ath | 3 | 5 | 1 | 29822 | CN | 21590.870 | 21590.950 | l/u | g | 79 |
| TGTTGAAAGTTAAACTTGATTTTGAATCAAGTTTAATTATTGGATCAATT | | | | | | | | | | |
| ATCCAATAATTAATTATGGCCAAATCCAA | | | | | | | | | | |
| ath | 3 | 1 | 1 | 7985 | TP | 3785.281 | 3785.359 | l/u | g | 79 |

| TGTTGAAAGTTAAACTTGATTTTGAATCAAGTTTAATTATTGGATCAATT | |
|---|---|
| ATCCAATAATTAATTATGGCCAAATCCAA | |
| Can form an AB symmetric pair of l/u Connectrons with a | |
| lifetime = 39 × 39 = 1521 | |
| | 79 |
| TGTTGAAAGTTAAACTTGATTTTGAATCAAGTTTAATTATTGGATCAATT | |
| ATCCAATAATTAATTATGGCCAAATCCAA | |
| | 79 |

| TGTTGAAAGTTAAACTTGATTTTGAATCAAGTTTAATTATTGGATCAATT | | | | | | | | |
|---|---|---|---|---|---|---|---|---|
| ATCCAATAATTAATTATGGCCAAATCCAA | | | | | | | | |
| 3780.765 | 3780.803 | 3780.820 | 3780.858 | --- | 3785.281 | 3785.319 | 3785.321 | 3785.359 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Description of an Asymmetric Lower-Upper Connectron Pair in E. coli

The connectron 14918 has a C1-T1 binding length of 27 bases and a C2-T2 binding length of 35 bases. The shorter of the two matches at 27 bases produces the lifetime for this connectron. The connectron 15118 has a C1-T1 binding length of 20 bases and a C2-T2 binding length of 22 bases. The shorter of the two matches at 20 bases produces the lifetime for this connectron. The lifetime of this pair of anti-dominant—dominant connectrons as shown in FIG. 9d is 540.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| eco | 14918 | 1 | 1 | 7316 | CN | 4454.807 | 4454.833 | l/u | g | 27 |
| AAATGCCGGATGCGGCGTGAACGCCTT | | | | | | | | | | |
| eco | 14918 | 1 | 1 | 6955 | TN | 4242.757 | 4242.783 | l/u | g | 27 |
| AAATGCCGGATGCGGCGTGAACGCCTT | | | | | | | | | | |
| eco | 14918 | 1 | 1 | 7316 | CN | 4454.810 | 4454.844 | l/u | g | 35 |
| TGCCGGATGCGGCGTGAACGCCTTATCCGGCCTAC | | | | | | | | | | |
| eco | 14918 | 1 | 1 | 6937 | TN | 4233.017 | 4233.051 | l/u | g | 35 |
| TGCCGGATGCGGCGTGAACGCCTTATCCGGCCTAC | | | | | | | | | | |
| eco | 15118 | 1 | 1 | 1544 | CP | 831.575 | 831.594 | l/u | g | 20 |
| TGTAGGCCGGATAAGGCGTT | | | | | | | | | | |
| eco | 15118 | 1 | 1 | 6939 | TP | 4232.999 | 4233.018 | l/u | g | 20 |
| TGTAGGCCGGATAAGGCGTT | | | | | | | | | | |
| eco | 15118 | 1 | 1 | 1544 | CP | 831.596 | 831.617 | l/u | g | 22 |
| ACGCCGCATCCGGCATTTCACA | | | | | | | | | | |
| eco | 15118 | 1 | 1 | 6957 | TP | 4242.783 | 4242.804 | l/u | g | 22 |
| ACGCCGCATCCGGCATTTCACA | | | | | | | | | | |
| Found L/U AD AB-CD Connectron pair for 14918 and 15118 with a | | | | | | | | | | |
| lifetime = 27 × 20 = 540 | | | | | | | | | | |
| | .000 | .001 | | | | | | | | |

| | | | | | | | | |
|---|---|---|---|---|---|---|---|---|
| 4242.757 | 4242.783 | 4233.017 | 4233.051 | --- | 4232.999 | 4233.018 | 4242.783 | 4242.804 |

```
                      .-----.
                    /  \
                  /  \
  279.155 *  *270.981
                  \ /
                    \\ / /
                      \\ / /
        279.239  *.* 270.897
                        \ /
                            X
                        /  \
        270.895*  .  *279.252
                    /  /  \ \
                  /  /  \ \
                /  \
270.811* *279.336
            /  \
```

Description of an Asymmetric Lower-Upper Connectron Pair in S. tokodaii

The connectron 6416 has a C1-T1 binding length of 59 bases and a C2-T2 binding length of 60 bases. The shorter of the two matches at 59 bases produces the lifetime for this connectron. The connectron 6477 has a C1-T1 binding length of 189 bases and a C2-T2 binding length of 36 bases. The shorter of the two matches at 36 bases produces the lifetime for this connectron. The lifetime of this pair of dominant—anti-dominant connectrons as shown in FIG. 9d is 2124.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| sto | 6416 | 1 | 1 | 3245 | CP | 1036.523 | 1036.581 | l/u | g | 59 |
| ACTCCCAGTGAGGGATAGGGGTAACGGACTGAAGACCCAGCCCGTGGTCT | | | | | | | | | | |
| ACCGCTGGA | | | | | | | | | | |
| sto | 6416 | 1 | 1 | 3439 | TP | 1079.594 | 1079.652 | l/u | g | 59 |
| ACTCCCAGTGAGGGATAGGGGTAACGGACTGAAGACCCAGCCCGTGGTCT | | | | | | | | | | |
| ACCGCTGGA | | | | | | | | | | |
| sto | 6416 | 1 | 1 | 3250 | CP | 1036.635 | 1036.694 | l/u | g | 60 |
| ATGAAGGTGGTAAACCACAAACCTATGAACCGCCCTAAGGGAACCCTCGC | | | | | | | | | | |
| CCTTTAGGGC | | | | | | | | | | |
| sto | 6416 | 1 | 1 | 3714 | TP | 1146.360 | 1146.419 | l/u | g | 60 |
| ATGAAGGTGGTAAACCACAAACCTATGAACCGCCCTAAGGGAACCCTCGC | | | | | | | | | | |
| CCTTTAGGGC | | | | | | | | | | |
| sto | 6477 | 1 | 1 | 618 | CN | 120.361 | 120.549 | l/u | g | 189 |
| CTATCCCTCACCAAGAGTTGCCCTCTGCTCTTGGCTCTTGGGGACTCGGG | | | | | | | | | | |
| GATATGTAGTTCTGTGCGGGGACACATATCTTCAGTATGCCCACCTTTGT | | | | | | | | | | |
| GGGCTTCCCCGCACTTTATTAATAGTTTTAAGCTAAGATTAAAAACTTTA | | | | | | | | | | |
| CCCCGCCTTAAAAGGCGAGGCTTGCCCCGCGTTTTGTCA | | | | | | | | | | |
| sto | 6477 | 1 | 1 | 3709 | TN | 1146.169 | 1146.357 | l/u | g | 189 |
| CTATCCCTCACCAAGAGTTGCCCTCTGCTCTTGGCTCTTGGGGACTCGGG | | | | | | | | | | |
| GATATGTAGTTCTGTGCGGGGACACATATCTTCAGTATGCCCACCTTTGT | | | | | | | | | | |
| GGGCTTCCCCGCACTTTATTAATAGTTTTAAGCTAAGATTAAAAACTTTA | | | | | | | | | | |
| CCCCGCCTTAAAAGGCGAGGCTTGCCCCGCGTTTTGTCA | | | | | | | | | | |
| sto | 6477 | 1 | 1 | 622 | CN | 120.590 | 120.625 | l/u | g | 36 |
| CACCCACCCCGCTCCGTTCGTCCAGCGGTAGACCAC | | | | | | | | | | |
| sto | 6477 | 1 | 1 | 3446 | TN | 1079.651 | 1079.688 | l/u | g | 36 |

CACCCACCCCGCTCCGTTCGTCCAGCGGTAGACCAC
Found L/U DA AB-CD Connectron pair for 6416 and 6477 with a
lifetime = 59 × 36 = 2124

| | |
|---|---|
| .001 | .003 |

| | | | | | | | | |
|---|---|---|---|---|---|---|---|---|
| 1079.594 | 1079.652 | 1146.360 | 1146.419 | --- | 1146.169 | 1146.357 | 1079.651 | 1079.686 |

```
                      .-----.
                    /  \
                  /  \
  279.155 *  *270.981
                  \ /
                    \\ / /
                      \\ / /
        279.239  *.* 270.897
                        \ /
                            X
                        /  \
        270.895*  .  *279.252
                    /  /  \ \
                  /  /  \ \
                /  \
270.811* *279.336
            /  \
```

Description of an Asymmetric Lower-Upper Connectron Pair in S. cerevisiae

The connectron 3814 has a C1-T1 binding length of 72 bases and a C2-T2 binding length of 72 bases. The either of the two matches at 72 bases produces the lifetime for this connectron. The connectron 3847 has a C1-T1 binding length of 81 bases and a C2-T2 binding length of 89 bases. The shorter of the two matches at 81 bases produces the lifetime for this connectron. The lifetime of this pair of anti-dominant—dominant connectrons as shown in FIG. 9d is 5832.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| yst | 3814 | 13 | 13 | 23498 | CP | 362.701 | 382.772 | l/u | g | 72 |
| ATGGAATCTATATTTCTACATACTAATATTACGATTATTCCTCATTCCGT | | | | | | | | | | |
| TTTATATGTTTCATTATCCTAT | | | | | | | | | | |
| yst | 3814 | 2 | 2 | 1896 | TN | 265.267 | 265.338 | l/u | g | 72 |
| ATGGAATCTATATTTCTACATACTAATATTACGATTATTCCTCATTCCGT | | | | | | | | | | |
| TTTATATGTTTCATTATCCTAT | | | | | | | | | | |
| yst | 3814 | 13 | 13 | 23498 | CP | 362.701 | 362.772 | l/u | g | 72 |
| ATGGAATCTATATTTCTACATACTAATATTACGATTATTCCTCATTCCGT | | | | | | | | | | |
| TTTATATGTTTCATTATCCTAT | | | | | | | | | | |
| yst | 3814 | 2 | 2 | 1495 | TN | 226.820 | 226.891 | l/u | g | 72 |
| ATGGAATCTATATTTCTACATACTAATATTACGATTATTCCTCATTCCGT | | | | | | | | | | |
| TTTATATGTTTCATTATCCTAT | | | | | | | | | | |
| yst | 3847 | 13 | 13 | 23551 | CN | 372.772 | 372.852 | l/u | g | 81 |
| AAACATATAAAACGGAATGAGGAATAATCGTAATATTAGTATGTAGAAAT | | | | | | | | | | |
| ATAGATTCCATTTTGAGGATTCCTATATCCT | | | | | | | | | | |
| yst | 3847 | 2 | 2 | 1496 | TP | 226.739 | 226.819 | l/u | g | 81 |
| AAACATATAAAACGGAATGAGGAATAATCGTAATATTAGTATGTAGAAAT | | | | | | | | | | |
| ATAGATTCCATTTTGAGGATTCCTATATCCT | | | | | | | | | | |
| yst | 3847 | 13 | 13 | 23551 | CN | 372.836 | 372.924 | l/u | g | 89 |
| GAGGATTCCTATATCCTCGAGGAGAACTTCTAGTATATTCTGTATACCTA | | | | | | | | | | |
| ATATTATAGCCTTTATCAACAATGGAATCCCAACAATTA | | | | | | | | | | |
| yst | 3847 | 2 | 2 | 1923 | TP | 265.340 | 265.428 | l/u | g | 89 |
| GAGGATTCCTATATCCTCGAGGAGAACTTCTAGTATATTCTGTATACCTA | | | | | | | | | | |
| ATATTATAGCCTTTATCAACAATGGAATCCCAACAATTA | | | | | | | | | | |
| Found L/U AD AB-CD Connectron pair for 3814 and 3847 with a | | | | | | | | | | |
| lifetime = 72 × 81 = 5832 | | | | | | | | | | |
| | .002 | .001 | | | | | | | | |

| | | | | | | | | |
|---|---|---|---|---|---|---|---|---|
| 265.267 | 265.338 | 226.820 | 226.891 | --- | 226.739 | 226.819 | 265.340 | 265.428 |

```
                      .-----.
                    /  \
                  /  \
  279.155 *  *270.981
                  \ /
                    \\ / /
                      \\ / /
        279.239  *.* 270.897
                        \ /
                            X
                        /  \
        270.895*  .  *279.252
                    /  /  \ \
                  /  /  \ \
                /  \
270.811* *279.336
            /  \
```

Description of an Asymmetric Lower-Upper Connectron Pair in C. elegans

The connectron 23175 has a C1-T1 binding length of 15 bases and a C2-T2 binding length of 18 bases. The shorter of the two matches at 15 bases produces the lifetime for this connectron. The connectron 23179 has a C1-T1 binding length of 16 bases and a C2-T2 binding length of 19 bases. The shorter of the two matches at 16 bases produces the lifetime for this connectron. The lifetime of this pair of dominant—anti-dominant connectrons as shown in FIG. 9c is 240.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| wrm | 23175 | 4 | 2 | 22854 | CP | 708.778 | 708.792 | l/u | g | 15 |
| TGGTCTGCTAAATCG | | | | | | | | | | |
| wrm | 23175 | 4 | 2 | 21925 | TP | 415.203 | 415.217 | l/u | g | 15 |
| TGGTCTGCTAAATCG | | | | | | | | | | |
| wrm | 23175 | 4 | 2 | 22854 | CP | 708.793 | 708.810 | l/u | g | 18 |
| AAACTTGTAGTTTGTAGT | | | | | | | | | | |
| wrm | 23175 | 4 | 2 | 22166 | TP | 486.479 | 486.496 | l/u | g | 18 |
| AAACTTGTAGTTTGTAGT | | | | | | | | | | |
| wrm | 23179 | 4 | 2 | 24763 | CN | 1373.569 | 1373.584 | l/u | g | 16 |
| ATTTAGCAGACCCAAA | | | | | | | | | | |
| wrm | 23179 | 4 | 2 | 22165 | TN | 486.461 | 486.476 | l/u | g | 16 |
| ATTTAGCAGACCCAAA | | | | | | | | | | |
| wrm | 23179 | 4 | 2 | 24763 | CN | 1373.554 | 1373.572 | l/u | g | 19 |
| AAACTACTACAAATTTCGATTT | | | | | | | | | | |
| wrm | 23179 | 4 | 2 | 21926 | TN | 415.212 | 415.230 | l/u | g | 19 |
| AAACTACAAATTTCGATTT | | | | | | | | | | |
| Found L/U DA AB-CD Connectron pair for 23175 and 23179 with a | | | | | | | | | | |
| lifetime = 15 × 16 = 240 | | | | | | | | | | |
| | .005 | .003 | | | | | | | | |

| | | | | | | | | |
|---|---|---|---|---|---|---|---|---|
| 415.203 | 415.217 | 486.479 | 486.496 | --- | 486.461 | 486.476 | 415.212 | 415.230 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Description of an Asymmetric Lower-Upper Connectron Pair in H. sapiens

The connectron 383992 has a C1-T1 binding length of 39 bases and a C2-T2 binding length of 41 bases. The shorter of the two matches at 39 bases produces the lifetime for this connectron. The connectron 383993 has a C1-T1 binding length of 40 bases and a C2-T2 binding length of 34 bases. The shorter of the two matches at 34 bases produces the lifetime for this connectron. The lifetime of this pair of dominant—anti-dominant connectrons as shown in FIG. 9c is 1326.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |

| hsd | 383992 | 920 | 19 | 756303 | CP | 21789.055 | 21789.092 | u/d | g | 39 |
|---|---|---|---|---|---|---|---|---|---|---|
| AGCCCGAGCCCCACCTCTCCCTTAGGGACCTCCGCCCAC | | | | | | | | | | |
| hsd | 383992 | 920 | 19 | 756563 | TP | 21820.715 | 21820.754 | u/d | 9 | 39 |
| AGCCCGAGCCCCACCTCTCCCTTAGGGACCTCCGCCCAC | | | | | | | | | | |
| hsd | 383992 | 920 | 19 | 756303 | CP | 21789.080 | 21789.121 | u/d | g | 41 |
| ACCTCCGCCCACCCTACCCTCAAGCCAGGATCCCCGGAGCG | | | | | | | | | | |
| hsd | 383992 | 920 | 19 | 756615 | TP | 21827.379 | 21827.420 | u/d | g | 41 |
| ACCTCCGCCCACCCTACCCTCAAGCCAGGATGCCCGGAGCG | | | | | | | | | | |
| hsd | 383993 | 920 | 19 | 756433 | CN | 21808.781 | 21808.820 | u/d | g | 40 |
| CCTAAGGGAGAGGTGGGGCTCGGGCTGAATCCCTCGTTGG | | | | | | | | | | |
| hsd | 383993 | 920 | 19 | 756614 | TN | 21827.338 | 21827.377 | u/d | g | 40 |
| CCTAAGGGAGAGGTGGGGCTCGGGCTGAATCCCTCGTTGG | | | | | | | | | | |
| hsd | 383993 | 920 | 19 | 756433 | CN | 21808.740 | 21808.773 | u/d | g | 34 |
| GCTCCGGGCATCCTGGCTTGAGGGTAGAGTGGGC | | | | | | | | | | |
| hsd | 383993 | 920 | 19 | 756564 | TN | 21820.748 | 21820.781 | u/d | g | 34 |
| GCTCCGGGCATCCTGGCTTGAGGGTAGAGTGGGC | | | | | | | | | | |
| Found L/U DA AB-CD Connectron pair for 383992 and 383993 with a | | | | | | | | | | |
| lifetime = 39 × 34 = 1326 | | | | | | | | | | |
| | 0.006 | 0.002 | | | | | | | | |

| | | | | | | | | |
|---|---|---|---|---|---|---|---|---|
| 21820.715 | 21820.754 | 21827.379 | 21827.420 | --- | 21827.338 | 21827.377 | 21820.748 | 21820.781 |

```
                      .-----.
                    /  \
                  /  \
  279.155 *  *270.981
                  \ /
                    \ \ / /
                      \ \ / /
        279.239  *.* 270.897
                          \ /
                            X
                        /  \
        270.895*  .  *279.252
                    /  / \ \
                  /  /  \ \
                /  \
270.811* *279.336
            /  \
```

Description of an Asymmetric Lower-Upper Connectron Pair in A. thaliana

The connectron 188312 has a C1-T1 binding length of 20 bases and a C2-T2 binding length of 30 bases. The shorter of the two matches at 20 bases produces the lifetime for this connectron. The connectron 188397 has a C1-T1 binding length of 30 bases and a C2-T2 binding length of 16 bases. The shorter of the two matches at 16 bases produces the lifetime for this connectron. The lifetime of this pair of dominant—anti-dominant connectrons as shown in FIG. 9c is 340.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| ath | 188312 | 18 | 4 | 269631 | CP | 5320.517 | 5320.536 | u/d | g | 20 |
| TTGTAGACGTATGGTGGTGG | | | | | | | | | | |
| ath | 188312 | 18 | 4 | 269507 | TP | 5311.160 | 5311.179 | u/d | g | 20 |
| TTGTAGACGTATGGTGGTGG | | | | | | | | | | |
| ath | 188312 | 18 | 4 | 269631 | CP | 5320.519 | 5320.548 | u/d | g | 30 |
| GTAGACGTATGGTGGTGGTGGAGACTTGTA | | | | | | | | | | |
| ath | 188312 | 18 | 4 | 269890 | TP | 5340.361 | 5340.390 | u/d | g | 30 |
| GTAGACGTATGGTGGTGGTGGAGACTTGTA | | | | | | | | | | |
| ath | 188397 | 18 | 4 | 269741 | CN | 5324.883 | 5324.921 | u/d | g | 39 |
| GCTCTCCACCACCACCATACTACAGTCCATCTCCAAAGG | | | | | | | | | | |
| ath | 188397 | 18 | 4 | 269881 | TN | 5340.322 | 5340.360 | u/d | g | 39 |
| GCTCTCCACCACCACCATACTACAGTCCATCTCCAAAGG | | | | | | | | | | |
| ath | 188397 | 18 | 4 | 269741 | CN | 5324.867 | 5324.882 | u/d | g | 16 |
| CCACCATACGTCTACA | | | | | | | | | | |
| ath | 188397 | 18 | 4 | 269509 | TN | 5311.176 | 5311.191 | u/d | g | 16 |
| CCACCATACGTCTACA | | | | | | | | | | |
| Found L/U DA AB-CD Connectron pair for 188312 and 188397 with a | | | | | | | | | | |
| lifetime = 20 × 16 = 320 | | | | | | | | | | |
| | 0.003 | 0.001 | | | | | | | | |

| | | | | | | | | |
|---|---|---|---|---|---|---|---|---|
| 5311.160 | 5311.179 | 5340.361 | 5340.390 | --- | 5340.322 | 5340.360 | 5311.176 | 5311.191 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Description of an Asymmetric Left-Right Connectron Pair in E. coli

The connectron 3707 has a C1-T1 binding length of 21 bases and a C2-T2 binding length of 19 bases. The shorter of the two matches at 19 bases produces the lifetime for this connectron. The connectron 3763 has a C1-T1 binding length of 42 bases and a C2-T2 binding length of 37 bases. The shorter of the two matches at 37 bases produces the lifetime for this connectron. The lifetime of this pair of dominant—dominant connectrons as shown in FIG. 10a is 703.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| eco | 3707 | 1 | 1 | 3906 | CN | 2338.350 | 2338.370 | l/r | g | 21 |
| AACGCCTTLTCCGGCCTLCGG | | | | | | | | | | |
| eco | 3707 | 1 | 1 | 689 | TP | 374.169 | 374.189 | l/r | g | 21 |
| AACGCCTTLTCCGGCCTLCGG | | | | | | | | | | |
| eco | 3707 | 1 | 1 | 3906 | CN | 2338.380 | 2338.398 | l/r | g | 19 |
| GTLGGCCTGATLAGACGCG | | | | | | | | | | |
| eco | 3707 | 1 | 1 | 707 | TN | 376.619 | 376.637 | l/r | g | 19 |
| GTLGGCCTGATLAGACGCG | | | | | | | | | | |
| eco | 3763 | 1 | 1 | 709 | CP | 376.712 | 376.753 | l/r | g | 42 |
| GTLGGCCGGATLAGGCGTTCACGCCGCATCCGGCAGTCGTGC | | | | | | | | | | |
| eco | 3763 | 1 | 1 | 690 | TN | 374.152 | 374.193 | l/r | g | 42 |
| GTLGGCCGGATLAGGCGTTCACGCCGCATCCGGCAGTCGTGC | | | | | | | | | | |
| eco | 3763 | 1 | 1 | 709 | CP | 376.717 | 376.753 | l/r | g | 37 |
| CCGGATLAGGCGTTCACGCCGCATCCGGCAGTCGTGC | | | | | | | | | | |
| eco | 3763 | 1 | 1 | 706 | TP | 376.617 | 376.653 | l/r | g | 37 |
| CCGGATLAGGCGTTCACGCCGCATCCGGCAGTCGTGC | | | | | | | | | | |
| Found L/R DD AB-CD Connectron pair for 3707 and 3763 with a | | | | | | | | | | |
| lifetime = 19 × 37 = 703 | | | | | | | | | | |
| | .004 | .002 | | | | | | | | |

| | | | | | | | | |
|---|---|---|---|---|---|---|---|---|
| 374.169 | 374.189 | 376.619 | 376.637 | --- | 374.152 | 374.193 | 376.617 | 376.653 |

```
                      .-----.
                    /  \
                  /  \
  279.155 *  *270.981
                  \ /
                    \\ / /
                      \\ / /
        279.239  *.* 270.897
                          \ /
                            X
                      /  \
        270.895*  .  *279.252
                    /  /  \ \
                  /  /  \ \
                /  \
270.811* *279.336
            /  \
```

Description of an Asymmetric Left-Right Connectron Pair in S. cerevisiae

The connectron 6834 has a C1-T1 binding length of 105 bases and a C2-T2 binding length of 38 bases. The shorter of the two matches at 38 bases produces the lifetime for this connectron. The connectron 6944 has a C1-T1 binding length of 152 bases and a C2-T2 binding length of 143 bases. The shorter of the two matches at 143 bases produces the lifetime for this connectron. The lifetime of this pair of dominant—anti-dominant connectrons as shown in FIG. 10c is 5434.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| yst | 6834 | 7 | 7 | 10928 | CN | 111.321 | 111.425 | l/r | g | 105 |
| CGGTGTTAGAAGATGACGCAAATGATGAGAAATAGTCATCTAAATTAGTG | | | | | | | | | | |
| GAAGCTGAAACGCAAGGATTGATAATGTAATAGCATCAATGAATATTAAC | | | | | | | | | | |
| ATATA | | | | | | | | | | |
| yst | 6834 | 3 | 3 | 2988 | TP | 84.359 | 84.463 | l/r | g | 105 |
| CGGTGTTAGAAGATGACGCAAATGATGAGAAATAGTCATCTAAATTAGTG | | | | | | | | | | |
| GAAGCTGAAACGCAAGGATTGATAATGTAATAGGATCAATGAATATTAAC | | | | | | | | | | |
| ATATA | | | | | | | | | | |
| yst | 6834 | 7 | 7 | 10945 | CN | 111.449 | 111.486 | l/r | g | 38 |
| TCATCTACTAACTAGTATTTACGTTACTAGTATATTAT | | | | | | | | | | |
| yst | 6834 | 3 | 3 | 3500 | TN | 168.765 | 168.802 | l/r | g | 38 |
| TCATCTACTAACTAGTATTTACGTTACTAGTATATTAT | | | | | | | | | | |
| yst | 6944 | 4 | 4 | 5116 | CN | 645.641 | 645.792 | l/r | g | 152 |
| TCATCTACTAACTAGTATTTACGTTACTAGTATATTATCATATACGGTGT | | | | | | | | | | |
| TAGAAGATGACGCAAATGATGAGAAATAGTCATCTAAATTAGTGGAAGCT | | | | | | | | | | |
| GAAACGCAAGGATTGATAATGTAATAGGATCAATGAATATTAACATATAA | | | | | | | | | | |
| AA | | | | | | | | | | |
| yst | 6944 | 3 | 3 | 2991 | TP | 84.315 | 84.466 | l/r | g | 152 |
| TCATCTACTAACTAGTATTTACCTTACTAGTATATTATCATATACGGTGT | | | | | | | | | | |
| TAGAAGATGACGCAAATGATGAGAAATAGTCATCTAAATTAGTGGAAGCT | | | | | | | | | | |
| GAAACGCAAGGATTGATAATGTAATAGGATCAATGAATATTAACATATAA | | | | | | | | | | |
| AA | | | | | | | | | | |
| yst | 6944 | 4 | 4 | 5116 | CN | 645.641 | 645.783 | l/r | g | 143 |
| TCATCTACTAACTAGTATTTACGTTACTAGTATATTATCATATACGGTGT | | | | | | | | | | |
| TAGAAGATGACGCAAATGATGAGAAATAGTCATCTAAATTAGTGGAAGCT | | | | | | | | | | |
| GAAACGCAAGGATTGATAATGTAATAGGATCAATGAATATTAA | | | | | | | | | | |
| yst | 6944 | 3 | 3 | 3496 | TN | 168.762 | 168.904 | l/r | g | 143 |

TCATCTACTAACTAGTATTTACGTTACTAGTATATTATCATATACGGTGT
TAGAAGATGACGCAAATGATGAGAAATAGTCATCTAAATTAGTGGAAGCT
GAAACGCAAGGATTGATAATGTAATAGGATCAATGAATATTAA
Found L/R DA AB-CD Connectron pair for 6834 and 6944 with a
lifetime = 38 × 143 = 5434

| | |
|---|---|
| .003 | .003 |

| | | | | | | | | |
|---|---|---|---|---|---|---|---|---|
| 84.359 | 84.463 | 168.765 | 168.802 | --- | 84.315 | 84.466 | 168.762 | 168.904 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Description of an Asymmetric Left-Right Connectron Pair in C. elegans

The connectron 40849 has a C1-T1 binding length of 34 bases and a C2-T2 binding length of 34 bases. The either of the two matches at 34 bases produces the lifetime for this connectron. The connectron 40850 has a C1-T1 binding length of 48 bases and a C2-T2 binding length of 39 bases. The shorter of the two matches at 39 bases produces the lifetime for this connectron. The lifetime of this pair of anti-dominant—dominant connectrons as shown in FIG. 10d is 1326.

genome

| | |
|---|---|
| \| | Connection id |

| \| | \| | chromosome | | | | | | | | |
|---|---|---|---|---|---|---|---|---|---|---|
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |

| wrm | 40849 | 6 | 2 | 51392 | CN | 13819.470 | 13819.500 | l/r | g | 34 |
|---|---|---|---|---|---|---|---|---|---|---|
| ACCGAACCCAACGGCCCTCTTTAGGGCCACAAAT | | | | | | | | | | |
| wrm | 40849 | 6 | 2 | 51379 | TN | 13817.594 | 13817.630 | l/r | g | 34 |
| ACCGAACCCAACGGCCCTCTTTAGGGCCACAAAT | | | | | | | | | | |
| wrm | 40849 | 6 | 2 | 51392 | CN | 13819.470 | 13819.500 | l/r | g | 34 |
| ACCGAACCCAACGGCCCTCTTTAGGGCCACAAAT | | | | | | | | | | |
| wrm | 40849 | 6 | 2 | 51400 | TP | 13820.550 | 13820.583 | l/r | g | 34 |
| ACCGAACCCAACGGCCCTCTTTAGGGCCACAAAT | | | | | | | | | | |
| wrm | 40850 | 6 | 2 | 51410 | CN | 13820.791 | 13820.840 | l/r | g | 48 |
| CAACACACCTAACCGAACCCAACGGCCCTCTTTAGGGCCACAAATGTT | | | | | | | | | | |
| wrm | 40850 | 6 | 2 | 51379 | TN | 13817.583 | 13817.630 | l/r | g | 48 |
| CAACACACCTAACCGAACCCAACGGCCCTCTTTAGGGCCACAAATGTT | | | | | | | | | | |
| wrm | 40850 | 6 | 2 | 51410 | CN | 13820.800 | 13820.840 | l/r | g | 39 |
| CTAACCGAACCCAACGGCCCTCTTTAGGGCCACAAATGT | | | | | | | | | | |
| wrm | 40850 | 6 | 2 | 51400 | TP | 13820.550 | 13820.584 | l/r | g | 39 |
| CTAACCGAACCCAACGGCCCTCTTTAGGGCCACAAATGT | | | | | | | | | | |
| Found L/R AD AB-CD Connectron pair for 40849 and 40850 with a | | | | | | | | | | |
| lifetime = 34 × 39 = 1326 | | | | | | | | | | |
| | .003 | .003 | | | | | | | | |

| | | | | | | | | |
|---|---|---|---|---|---|---|---|---|
| 13817.595 | 13817.628 | 13820.550 | 13820.583 | --- | 13817.584 | 13817.631 | 13820.547 | 13820.585 |

```
                      .-----.
                    /  \
                  /  \
  279.155 *  *270.981
                  \ /
                    \ \ / /
                      \ \ / /
        279.239  *.* 270.897
                          \ /
                            X
                        /  \
        270.895*  .  *279.252
                    /  /  \ \
                  /  /  \ \
                /  \
270.811* *279.336
            /  \
```

Description of an Asymmetric Left-Right Connectron Pair in H. sapiens

The connectron 67620 has a C1-T1 binding length of 38 bases and a C2-T2 binding length of 33 bases. The shorter of the two matches at 33 bases produces the lifetime for this connectron. The connectron 67621 has a C1-T1 binding length of 41 bases and a C2-T2 binding length of 42 bases. The shorter of the two matches at 41 bases produces the lifetime for this connectron. The lifetime of this pair of dominant—anti-dominant connectrons as shown in FIG. 10c is 1353.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| hsd | 67620 | 100 | 1 | 96091 | CN | 1705.996 | 1706.033 | l/r | g | 36 |
| GTGAAACCCCGTCTCTACTAAAAATACAAAAAATTAGC | | | | | | | | | | |
| hsd | 67620 | 60 | 1 | 78101 | TP | 218.397 | 218.434 | l/r | g | 38 |
| GTGAAACCCCGTCTCTACTAAAAATACAAAAAATTAGC | | | | | | | | | | |
| hsd | 67620 | 100 | 1 | 96101 | CN | 1705.970 | 1706.002 | l/r | g | 33 |
| AGGTCAGGAGATCGAGACCATCCTGGCTAACAC | | | | | | | | | | |
| hsd | 67620 | 60 | 1 | 78110 | TN | 234.341 | 234.373 | l/r | g | 33 |
| AGGTCAGGAGATCGAGACCATCCTGGCTAACAC | | | | | | | | | | |
| hsd | 67621 | 100 | 1 | 98781 | CN | 3142.085 | 3142.125 | l/r | g | 41 |
| CGGTGAAACCCCGTCTCTACTAAAAATACAAAAAATTAGCC | | | | | | | | | | |
| hsd | 67621 | 60 | 1 | 78101 | TP | 218.395 | 218.435 | l/r | g | 41 |
| CGGTGAAACCCCGTCTCTACTAAAAATACAAAAAATTAGCC | | | | | | | | | | |
| hsd | 67621 | 100 | 1 | 98781 | CN | 3142.052 | 3142.093 | l/r | g | 42 |
| GAGGTCAGGAGATCGAGACCATCCTGGCTAACACGGTGAAAC | | | | | | | | | | |
| hsd | 67621 | 60 | 1 | 78110 | TN | 234.340 | 234.381 | l/r | g | 42 |
| GAGGTCAGCAGATCGAGACCATCCTGGCTAACACGGTGAAAC | | | | | | | | | | |
| Found L/R DA AB-CD Connectron pair for 67620 and 67621 with a | | | | | | | | | | |
| lifetime = 33 × 41 = 1353 | | | | | | | | | | |
| | 0.001 | 0.001 | | | | | | | | |

| | | | | | | | | |
|---|---|---|---|---|---|---|---|---|
| 218.397 | 218.434 | 234.341 | 234.373 | --- | 218.395 | 218.435 | 234.340 | 234.381 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Description of an Asymmetric Left-Right Connectron Pair in A. thaliana

The connectron 5 has a C1-T1 binding length of 28 bases and a C2-T2 binding length of 35 bases. The shorter of the two matches at 28 bases produces the lifetime for this connectron. The connectron 6 has a C1-T1 binding length of 37 bases and a C2-T2 binding length of 68 bases. The shorter of the two matches at 37 bases produces the lifetime for this connectron. The lifetime of this pair of anti-dominant—dominant connectrons as shown in FIG. 10d is 1036.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |

| ath | 5 | 15 | 3 | 102175 | CN | 12540.150 | 12540.174 | l/r | g | 28 |
|---|---|---|---|---|---|---|---|---|---|---|
| ATCATCAATGAACTCATTTGGCTAAGGT | | | | | | | | | | |
| ath | 5 | 15 | 3 | 102902 | TN | 13558.720 | 13558.750 | l/r | g | 28 |
| ATCATCAATGAACTCATTTGGCTAAGGT | | | | | | | | | | |
| ath | 5 | 15 | 3 | 102176 | CN | 12540.184 | 12540.220 | l/r | g | 35 |
| ACATTCATTAGTTCTGGAACGTGAATCAAGCAATG | | | | | | | | | | |
| ath | 5 | 15 | 3 | 103090 | TP | 13634.210 | 13634.240 | l/r | g | 35 |
| ACATTCATTAGTTCTGGAACGTGAATCAAGCAATG | | | | | | | | | | |
| ath | 6 | 15 | 3 | 103067 | CP | 13626.660 | 13626.700 | l/r | g | 37 |
| ATGCATCATCAATGAACTCATTTGGCTAAGGTGAAGG | | | | | | | | | | |
| ath | 6 | 15 | 3 | 102902 | TN | 13558.713 | 13558.750 | l/r | g | 37 |
| ATGCATCATCAATGAACTCATTTGGCTAAGGTGAAGG | | | | | | | | | | |
| ath | 6 | 15 | 3 | 103067 | CP | 13626.624 | 13626.691 | l/r | g | 68 |
| TTTAACATTCATTAGTTCTGGAACGTGAATCAAGCAATGCATCATCAATG | | | | | | | | | | |
| AACTCATTTGGCTAAGGT | | | | | | | | | | |
| ath | 6 | 15 | 3 | 103090 | TP | 13634.202 | 13634.270 | l/r | g | 68 |
| TTTAACATTCATTAGTTCTGGAACGTGAATCAAGCAATGCATCATCAATG | | | | | | | | | | |
| AACTCATTTGGCTAAGGT | | | | | | | | | | |
| Found L/R AD AB-CD Connectron pair for 5 and 6 with a | | | | | | | | | | |
| lifetime = 28 × 37 = 1036 | | | | | | | | | | |
| | .005 | .004 | | | | | | | | |

| | | | | | | | | |
|---|---|---|---|---|---|---|---|---|
| 13558.718 | 13558.745 | 13634.206 | 13634.240 | --- | 13558.714 | 13558.750 | 13634.202 | 13634.269 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Design of an Asymmetric Lower-Upper Connectron Pair in S. cerevisiae

There are many ways to design a pair of connectrons. In this example we have chosen to replace the C1 source and the T1 target of the upper naturally occuring connectron with another sequence. Design of a connectron pair can be accomplished by anyone skilled the art by modifying and/or replacing any of the sources and targets in the four positions of either a lower-upper or a left-right connectron pair. A totally synthetic pair of dominant—anti-dominant connectrons could also be designed de-novo.

The connectron 5441 has a C1-T1 binding length of 82 bases and a C2-T2 binding length of 35 bases. The shorter of the two matches at 34 bases produces the lifetime for this connectron. The connectron 5500 has a C1-T1 binding length of 16 bases and a C2-T2 binding length of 16 bases. Either of the two matches at 16 bases produces the lifetime for this connectron. The lifetime of this pair of anti-dominant—dominant connectrons as shown in FIG. 9c is 544.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |
| yst | 5441 | 3 | 3 | 2944 | CP | 84.112 | 84.193 | l/u | g | 82 |
| ATACGTTTGAAGAATCACTTTATGGATTGAAACAAAGTGGAGCGAACTG | | | | | | | | | | |
| GTACGAAACTATCAAATCATACCTGATAAAAC | | | | | | | | | | |
| yst | 5441 | 3 | 3 | 2901 | TP | 82.743 | 82.824 | l/u | g | 82 |
| ATACGTTTGAAGAATCACTTTATGGATTGAAACAAAGTGGAGCGAACTG | | | | | | | | | | |
| GTACGAAACTATCAAATCATACCTGATAAAAC | | | | | | | | | | |
| yst | 5441 | 3 | 3 | 2965 | CP | 84.195 | 84.228 | l/u | g | 34 |
| GAAACGTGACGGTACTCATAAAGCTAGATTTGTT | | | | | | | | | | |
| yst | 5441 | 3 | 3 | 3529 | TP | 169.327 | 169.360 | l/u | g | 34 |
| GAAACGTCACGGTACTCATAAAGCTAGATTTGTT | | | | | | | | | | |
| yst | 5500 | 3 | 3 | 3387 | CN | 151.534 | 151.549 | l/u | g | 16 |
| TAATTGTTGGGATTCG | | | | | | | | | | |
| yst | 5500 | 3 | 3 | 3526 | TN | 169.308 | 169.323 | l/u | g | 16 |
| TAATTGTTGGGATTCC | | | | | | | | | | |
| yst | 5500 | 3 | 3 | 3387 | CN | 151.516 | 151.531 | l/u | g | 16 |
| AAAGGCTATAATATTA | | | | | | | | | | |
| yst | 5500 | 3 | 3 | 2905 | TN | 82.825 | 82.840 | l/u | g | 16 |

AAAGGCTATAATATTA
Found L/U DA AB-CD Connectron pair for 5441 and 5500 with a
lifetime = 34 × 16 = 544

| | |
|---|---|
| .001 | .004 |

| | | | | | | | | |
|---|---|---|---|---|---|---|---|---|
| 82.743 | 82.824 | 169.327 | 169.360 | --- | 169.308 | 169.323 | 82.825 | 82.840 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

Design of an Asymmetric Lower-Upper Connectron Pair in H. sapiens

There are many ways to design a pair of connectrons. In this example we have chosen to replace the C1 source and the T1 target of the right naturally occuring connectron with another sequence. Design of a connectron pair can be accomplished by anyone skilled the art by modifying and/or replacing any of the sources and targets in the four positions of either a lower-upper or a left-right connectron pair. A totally synthetic pair of anti-dominant—dominant connectrons could also be designed de-novo.

The connectron 395760 has a C1-T1 binding length of 32 bases and a C2-T2 binding length of 32 bases. Either of the two matches at 32 bases produces the lifetime for this connectron. The connectron 395762 has a C1-T1 binding length of 40 bases and a C2-T2 binding length of 39 bases. The shorter of the two matches at 39 bases produces the lifetime for this connectron. The lifetime of this pair of anti-dominant—dominant connectrons as shown in FIG. 10c is 1248.

| genome | | | | | | | | | | |
|---|---|---|---|---|---|---|---|---|---|---|
| \| | Connection id | | | | | | | | | |
| \| | \| | chromosome | | | | | | | | |
| \| | \| | \| | contig | | | | | | | |
| \| | \| | \| | \| | (.groups) id | | | | | | |
| \| | \| | \| | \| | \| | type | | | | | |
| \| | \| | \| | \| | \| | \| | match start | | | | |
| \| | \| | \| | \| | \| | \| | \| | match stop | | | |
| \| | \| | \| | \| | \| | \| | \| | \| | type of Connectron | | |
| \| | \| | \| | \| | \| | \| | \| | \| | \| | source of Connection | |
| \| | \| | \| | \| | \| | \| | \| | \| | \| | \| | length of match |
| sequence of match | | | \| | \| | \| | \| | \| | \| | \| | \| |
| \| \| | \| | \| | \| | \| | \| | \| | \| | \| | \| | \| |

| hsd | 395760 | 920 | 19 | 747775 | CP | 17572.332 | 17572.363 | l/r | g | 32 |
|---|---|---|---|---|---|---|---|---|---|---|
| CCAGCCCCTCCTCCCTCAGACCCAGGAGTCCA | | | | | | | | | | |
| hsd | 395760 | 922 | 19 | 765474 | TN | 27988.178 | 27988.209 | l/r | g | 32 |
| CCAGCCCCTCCTCCCTCAGACCCAGGAGTCCA | | | | | | | | | | |
| hsd | 395760 | 920 | 19 | 747777 | CP | 17572.369 | 17572.400 | l/r | g | 32 |
| CCAGCCCCTCCTCCCTCAGACCCAGGAGTCCA | | | | | | | | | | |
| hsd | 395760 | 922 | 19 | 765567 | TP | 28004.852 | 28004.883 | l/r | g | 32 |
| CCAGCCCCTCCTCCCTCAGACCCAGGAGTCCA | | | | | | | | | | |
| hsd | 395762 | 920 | 19 | 747819 | CP | 17573.447 | 17573.486 | l/r | g | 40 |
| CCCCAGCCCCTCCTCCCTCAGACCCAGGAGTCCAGACCCC | | | | | | | | | | |
| hsd | 395762 | 922 | 19 | 765474 | TN | 27988.176 | 27988.215 | l/r | g | 40 |
| CCCCAGCCCCTCCTCCCTCAGACCCAGGAGTCCAGACCCC | | | | | | | | | | |
| hsd | 395762 | 920 | 19 | 747823 | CP | 17573.520 | 17573.557 | l/r | g | 39 |
| GGCCCCAGCCCCTCCTCCCTCAGACCCAGGAGTCCAGGT | | | | | | | | | | |
| hsd | 395762 | 922 | 19 | 765567 | TP | 28004.848 | 28004.887 | l/r | g | 39 |
| GGCCCCAGCCCCTCCTCCCTCAGACCCAGGAGTCCAGGT | | | | | | | | | | |
| Found L/R AD AB-CD Connectron pair for 395760 and 395762 with a | | | | | | | | | | |
| lifetime = 32 × 39 = 1248 | | | | | | | | | | |
| | 0.006 | 0.004 | | | | | | | | |

| | | | | | | | | |
|---|---|---|---|---|---|---|---|---|
| 27988.178 | 27988.209 | 28004.852 | 28004.883 | --- | 27988.176 | 27988.215 | 28004.848 | 28004.887 |

```
                      .-----.
                    /  \
                  /  \
  279.155 *  *270.981
                  \ /
                    \\ / /
                      \\ / /
        279.239  *.* 270.897
                          \ /
                            X
                        /  \
        270.895*  .  *279.252
                    /  /  \ \
                  /  /  \ \
                /  \
270.811* *279.336
            /  \
```

What is claimed is:

1. A method of identifying gene expression regulation mechanisms in a genome comprising detecting, by computer, the connectron pairs that are symmetrically related and compete to effect gene expression regulation.

2. A method of identifying gene expression regulation mechanisms in a genome comprising detecting, by computer, the connectron pairs that are symmetrically related and cooperate to effect gene expression regulation.

3. A method of identifying gene expression regulation mechanisms in a genome comprising detecting, by computer, the connectron pairs that are asymmetrically related and compete to effect gene expression regulation.

4. A method of identifying gene expression regulation mechanisms in a genome comprising detecting, by computer, the connectron pairs that are asymmetrically related and cooperate to effect gene expression regulation.

5. A method of designing gene expression regulation mechanisms in a genome comprising modeling, by computer, the connectron pairs that are symmetrically related and compete to effect gene expression regulation.

6. A method of designing gene expression regulation mechanisms in a genome comprising modeling, by computer, the connectron pairs that are symmetrically related and cooperate to effect gene expression regulation.

7. A method of designing gene expression regulation mechanisms in a genome comprising modeling, by computer, the connectron pairs that are asymmetrically related and compete to effect gene expression regulation.

8. A method of designing gene expression regulation mechanisms in a genome comprising modeling, by computer, the connectron pairs that are asymmetrically related and cooperate to effect gene expression regulation.

9. A method of genome investigation comprising identifying a new class of connectrons that bind to the major groove of double-stranded DNA in two directions.

10. A method of genome investigation comprising designing one or more new classes of connectrons that bind to the major groove of double-stranded DNA in two directions.

11. A method of genome investigation comprising identifying the relationship between an existing pair of connectrons in a genome.

12. A method of genome investigation comprising designing the relationship between a synthetic pair of connectrons in a genome.

13. A method for identifying the relationship between an existing pair of connectrons in a genome that act in a competitive mode such that with respect to the individual connectrons there is an increased lifetime of connectron control of a set of genes.

14. A method for designing a synthetic pair of connectrons in a genome that act in a competitive mode such that with respect to the individual connectrons there is an increased lifetime of connectron control of a set of genes.

15. A method for identifying the relationship between an existing pair of connectrons in a genome that act in a cooperative mode such that with respect to the individual connectrons there is an increased lifetime of connectron control of a set of genes.

16. A method for designing a synthetic pair of connectrons in a genome that act in a cooperative mode such that with respect to the individual connectrons there is an increased lifetime of connectron control of a set of genes.
